(19) United States
(12) Patent Application Publication
(10) Pub. No.: US 2013/0159832 A1
(43) Pub. Date: Jun. 20, 2013

(54) SYSTEMS AND METHODS FOR TRADING USING AN EMBEDDED SPREADSHEET ENGINE AND USER INTERFACE

(71) Applicant: BLACK POINT TECHNOLOGIES LLC, San Francisco, CA (US)

(72) Inventors: Rosario M. Ingargiola, Novato, CA (US); Jay Marvin, Sebastopol, CA (US)

(73) Assignee: BLACK POINT TECHNOLOGIES LLC, San Francisco, CA (US)

(21) Appl. No.: 13/712,439

(22) Filed: Dec. 12, 2012

Related U.S. Application Data
(60) Provisional application No. 61/569,688, filed on Dec. 12, 2011.

(51) Int. Cl. G06F 17/24

(52) U.S. Cl. CPC G06F 17/246
USPC 715/220

(57) ABSTRACT

Systems and methods for facilitating trading and trading analyses are presented herein. Aspects of the present invention include systems and methods for receiving real-time and historic data, caching and updating the data for access by an embedded spreadsheet engine with a spreadsheet user interface, processing the data using spreadsheet logic and functions, and generating electronic trading message orders. Embodiments of the present invention also support the publishing of and subscribing to data and trading messages. Embodiments of the present invention also support backtesting analyses.

### CROSS-REFERENCE TO RELATED APPLICATION

This application claims the priority benefit under 35 USC §119(e) to commonly assigned and co-pending U.S. Patent Application No. 61/569,688 (Attorney Docket No. 20095-1665P), filed on Dec. 12, 2011, entitled “SYSTEMS AND METHODS FOR TRADING USING AN EMBEDDED SPREADSHEET ENGINE AND USER INTERFACE,” and listing as inventors Rosario Ingargiola and Jay Marvin. The aforementioned patent document is incorporated by reference herein in its entirety.

### COPYRIGHT NOTICE

A portion of this patent document contains material which is subject to copyright protection. To the extent required by law, the copyright owner has no objection to the facsimile reproduction of the document, as it appears in the U.S. Patent and Trademark Office patent file or records, but otherwise reserves all copyright rights whatsoever.

### BACKGROUND

1. Field of Invention

The present patent document is directed towards systems and methods for data processing. More particularly, the present patent document is directed towards systems and methods for data processing for conducting trading.

2. Background of the Invention

Online trading of financial instruments such as stocks, options, futures, and foreign exchange has seen extraordinary growth globally. Many different products and services have been developed to support this growth and facilitate increasing online trading volume.

Typical broker-provided client program makes it possible for end users to see and analyze financial instrument and other data, view common indicators that might help with decision support and make trades. Examples of these client programs can be seen in the product offerings of any major brokerage, such as E-Trade and TD Ameritrade for equities and options trading, or GAIN and OANDA for foreign exchange trading.

It should be noted, however, that these broker-provided platforms typically come with substantial limitations. Accordingly, what is needed are systems and methods that provide better trading functionality, better access to data, and improved user features and customization.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the scope of the invention to these particular embodiments.

FIG. 1 depicts an electronic implementation of a system according to embodiments of the present invention.

FIG. 2 depicts block diagram of a workstation and a server that may be used to implement the processes and functions according to embodiments of the present invention.

FIG. 3 depicts a table illustrating a cache key methodology according to embodiments of the present invention.

FIGS. 4A and 4B depict dynamic caching according to embodiments of the present invention.

FIG. 5 depicts a table illustrating data aggregation according to embodiments of the present invention.

FIG. 6 depicts in-memory data table objects according to embodiments of the present invention.

FIGS. 7A, 7B, 7C, and 7D depicts custom functions according to embodiments of the present invention.

FIGS. 8A-C depicts named-range-template-based trading according to embodiments of the present invention.

FIGS. 9A, 9B, 9C, and 9D depicts custom functions related to feedback loop systems and methods according to embodiments of the present invention.

FIG. 10 depicts publishing and subscribing according to embodiments of the present invention.

FIG. 11 depicts custom functions for use with publishing and subscribing according to embodiments of the present invention.

FIG. 12 depicts a backtest template according to embodiments of the present invention.

FIG. 13 depicts backtest spreadsheet windowing according to embodiments of the present invention.

FIG. 14 depicts backtest spreadsheet workbook translation according to embodiments of the present invention.

FIG. 15 depicts parameter optimization according to embodiments of the present invention.

FIG. 16 depicts an alert custom function according to embodiments of the present invention.

FIG. 17 depicts browser-based controls according to embodiments of the present invention.

FIG. 18 depicts a global variable display according to embodiments of the present invention.

FIGS. 19A-E depict spreadsheet display user interfaces according to embodiments of the present invention.

FIG. 20 depicts data selection user interface according to embodiments of the present invention.

FIG. 21 depicts trading options user input control and display according to embodiments of the present invention.

FIG. 22 depicts a block diagram of an example of a computing system according to embodiments of the present invention.

### DESCRIPTION OF THE EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, including software, hardware, or firmware, or combinations thereof. Accordingly, the figures described herein are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules. Furthermore, connections between components within the figures are not intended to be limited to direct connections. Rather, data between these components may be modified, re-formatted, or otherwise changed by intermediary components. Also, additional or fewer connections may be used.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of such phrases in various places in the specification are not necessarily all referring to the same embodiment or embodiments. It shall also be noted that references to data delimiters, variable types, and array types are provided by way of example and not limitation. It shall also be noted that the terms “coupled” or “communicatively coupled” shall be understood to include direct connections, indirect connections through one or more intermediary devices, wireless connections, sockets, and passing messages intra-process. It shall be noted that the use of the terms “set,” “group,” and “array” in this patent document shall include any number of elements. The phrase “real-time” or “real time” shall be understood to be real time or a near real time given practical limitations of networking systems, processing delays, and other delays. Furthermore, it shall be noted that methods or algorithms steps may not be limited to the specific order set forth herein; rather, one skilled in the art shall recognize that certain steps may be performed in different orders, including being done contemporaneously.

As previously noted, online trading of financial instruments has seen extraordinary growth globally. Three components generally provided when online trading are:

(1) Data, which includes instrument price and other possible derivations as well as economic, news sentiment or any other data deemed relevant in the instrument modeling or decision making process;

(2) Decision Logic, which includes logic for collecting data, processing it to obtain an estimate or indication of how an instrument's price might change in the future, and logic for determining what instruments to trade and when and with what parameters, such that a trade can be routed to a trade execution venue; and

(3) Trade Messaging, which includes forming a message in the required protocol of the execution venue, containing parameters that govern what is to be traded as well as when and how.

Generally, in the context of online trading, each of the three components may be encapsulated by one or more programs that run on one or more computers or servers.

A broker typically supplies a desktop or web-browser-based client program with a Graphical User Interface (“GUI”) that may have the following main properties:

(1) is connected to the broker's designated data server hardware or feeds by means of an Application Programming Interface (“API”) of a program running on that hardware that controls the data feed;

(2) contains various charts and graphs to display the data as well as pre-defined decision logic, often referred to as technical or other indicators, which can be used for decision support and generally can be parameterized by the end user based upon their preferences; and

(3) GUI controls for initiating trade and that generates a trade message for transmission to the broker's designated trade execution server program.

The above-described broker-provided client program makes it possible for non-programming end users to see and analyze financial instrument and other data, view common indicators that might help with decision support and make trades, all without any programming

It should be noted, however, that the convenience and simplicity of these broker-provided platforms have typically come with substantial limitations. Among the limitations are real-time data updates and user customization in both analysis and setting trades.

The limitations may include the inability to:

(1) Obtain both real-time data updates and also historical data for analysis;

(2) Obtain un-throttled tick data (as opposed to controlled update frequencies using filtered or periodic snapshot data) for processing or analysis;

(3) Obtain data in at different desired frequency (e.g., tick data, 10 seconds, 30 seconds, 3 minute, 20 minute, etc.) especially if the frequency interval is not supported by the broker's data source;

(4) Manipulate the data in arbitrary, user-defined ways for analysis (e.g., calculate the price change over one or more prior data points;

(5) Create custom visualizations from custom data manipulations that update in real time (e.g., a bar chart of the price change over 5 different time frames, such as tick data, 10 seconds, 30 seconds, 3 minute, and 20 minute);

(6) Add custom decision logic that goes beyond parameterizing pre-defined indicators (e.g., IF the value of the 10 seconds, 30 seconds, 3 minute, and 20 minute one period price changes are all >0 THEN Buy, ELSE IF the value of the 10 seconds, 30 seconds, 3 minute, and 20 minute one period price change are all <0 THEN Sell ELSE Hold);

(7) Define and store trade message parameters for reference in decision logic;

(8) Define trade message parameters dynamically using custom logic (e.g., conditionalizing the amount based upon Profit/Loss for the current day);

(9) Conduct backtesting of the custom decision logic to simulate systematic trading based upon this logic;

(10) Conduct semi-automated trading using decision logic and stored trade message parameters, where the user is presented with each trade message triggered by the decision logic for approval or rejection;

(11) Conduct fully automated trading using decision logic and stored trade message parameters; and

(12) Generate real-time feedback loops related to pending orders, open positions, Profit/Loss, etc. that can be referenced by custom decision logic and dynamic trade message parameter setting logic.

A small number of broker-provided platforms have attempted to address some of these limitations in various ways. There are two general approaches to solving issues related to customization, advanced decision logic, and automated trading. The first approach is to provide a GUI-driven solution that allows users have more flexibility, but these types of solutions fall short of supporting arbitrary or near-arbitrary customization because users are limited to whatever has been represented in the GUI. The second approach is to provide a programming environment for creation of arbitrary logic. These solutions dramatically increase the complexity because they require substantial programming skills, often in a proprietary language. And, they generally still have limitations surrounding the creation of custom visualizations, trading, and incorporation of a real-time feedback loop into the logic.

Other solutions include the use of an electronic spreadsheet application as a GUI. Spreadsheet applications strike a balance because they are flexible enough to allow near-arbitrary customization of data processing and decision logic as well as visualizations, yet the programming environment is generally simple, standard formula-based programming that is much more accessible to the average online trader. In addition, add-on programming can extend the basic functionality.

Several requirements that aid effective use an electronic spreadsheet application as an online trading system may include: (1) Connectivity to data sources; (2) Making data accessible to spreadsheet formulas; (3) Connectivity to trade execution venues; (4) Triggering trades from spreadsheet formulas; and (5) Real-time feedback loop representing the state of the trading account.

Some approaches have coupled trading systems with a spreadsheet using one or more separate pieces of software. Dynamic Data Exchange (DDE), Object Linking and Embedding (OLE), Component Object Model (COM), which allows two running applications to communicate and share data. Such implementations also have drawbacks, including issues of latency and real-time operation. Most systems are incorporating what are commonly known as add-ins developed predominantly in Visual Basic for Applications (VBA), which also has drawbacks including issues of latency and real-time operation.

Presented herein are systems and methods that provide, among other things, better trading functionality, better access to data, and improved user features and customization.

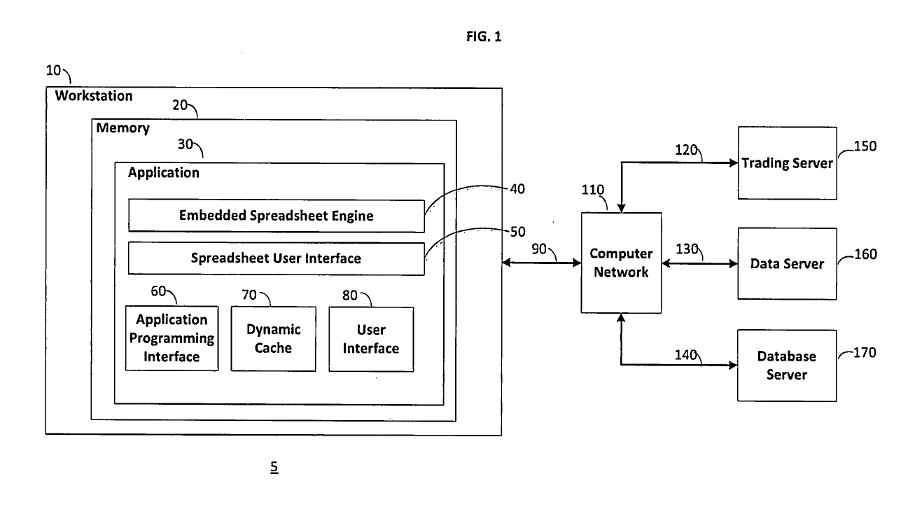

An embodiment of a system according to embodiments of the present invention is illustrated in FIG. 1. Referring to FIG. 1, the system 5 comprises an application 30 with an embedded spreadsheet engine 40, running on one or more workstations 10. Workstation 10 may be a computing device having a display, input device, processor, and memory 20, which may be interconnected. In embodiments, memory 20 contains one or more storage devices for storing a workstation program or programs, such as the application 30 with an embedded spreadsheet engine 40, for controlling one or more processors. In embodiments, application 30 comprises a spreadsheet user interface 50, dynamic cache 70, and a Graphical User Interface 80. The application 30 may also include an application programming interface module 60; or alternatively, as described above, application 30 may be resident in the memory of one or more servers, such as server 150, 160, or 170, or another server altogether.

Workstation 10 may be local or remote, and may be a laptop computer, personal computer, mainframe computer, dumb terminal, data display, Internet browser, personal digital assistant (PDA), smart phone, or any combination of the same. Workstations may be used to implement the application with the embedded spreadsheet engine according to embodiments the invention.

One or more real-time communication links 90 exists between the workstation containing the application 30 and a communications network 110 and communications links 120, 130, 140 to one or more servers for trading 150, data feeds 160 and a database 170. Communication network 110 may be any suitable communications network including the Internet, an intranet, a wide-area-network (WAN), a local-area-network (LAN), a wireless network, a digital subscriber line (DSL) network, a frame relay network, an asynchronous transfer mode (ATM) network, a virtual private network (VPN), or any combination of any of the same. Communications links 90, 120, 130 and 140 may be any communications links suitable for communicating data between workstations 10 and servers 150, 160 and 170, such as network links, dial-up links, wireless links, hard-wired links, etc.

Servers 150, 160, and 170 may each, or together, be one or more of any suitable server, computer, processor, or data processing device or combination of the same. The application 30 and all of the servers 150, 160 and 170 may run on one or any number of such suitable servers. Furthermore, server 150, 160 or 170 or any server representing all of them may also contain the application with the embedded spreadsheet engine 30 and merely transmit a Graphical User Interface or other display screens to the user at a user workstation display.

Embodiments of the present invention include improved systems and methods for receiving real-time data from server 160, caching data with dynamic cache 70 and updating the data within an embedded spreadsheet engine 40 with a spreadsheet user interface 50, processing the data using arbitrary spreadsheet logic inputted in 50 with the embedded spreadsheet engine 40, and generating electronic orders which are sent to a trading server 150.

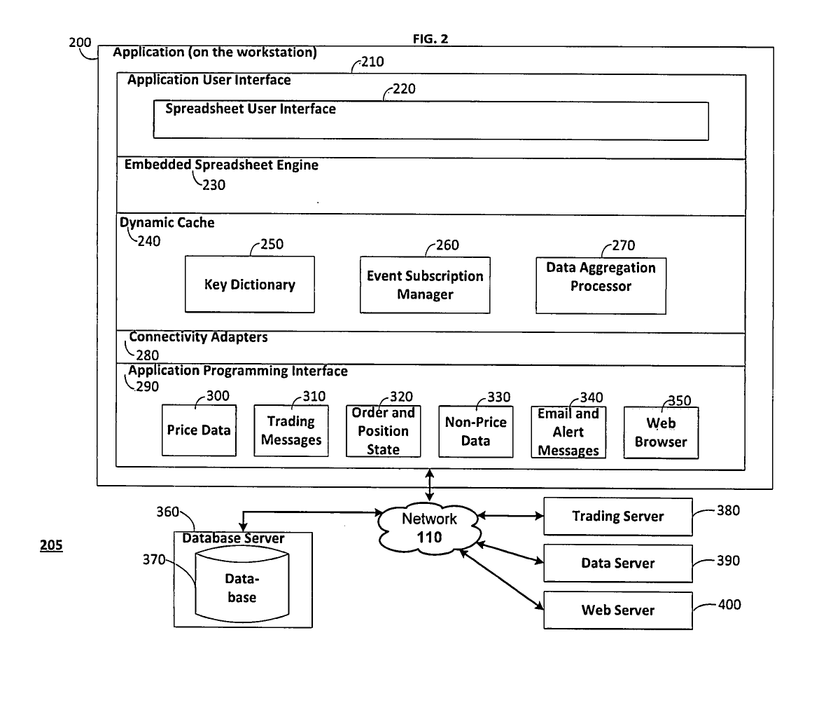

FIG. 2 illustrates in more detail a system with a trading application according to embodiments of the present invention. Referring to FIG. 2, the application 200 comprises a user interface 210 (which comprises numerous features more fully described later), as well as a spreadsheet user interface 220. The application 200 also comprises an embedded spreadsheet engine 230, which may, in embodiments, be in the form of a dynamically linked library (DLL), or in alternate embodiments, be entirely implemented within the application 200, or accessed, through any suitable application programming interface.

The application 200, in embodiments, also comprises an in-memory dynamic cache 240, which is accessed by spreadsheet formulas within cells within the spreadsheet user interface 220 and the data therein is read into cells and processed by the embedded spreadsheet engine 230. In embodiments, the dynamic cache 240 is populated by an event subscription manager 260, which creates entries in the hash table of keys 250 in the dynamic cache 240 based upon parameters of a custom function, such as SYM( ) (which is explained in more detail below). In embodiments, the parameters are entered into one or more cells in the spreadsheet user interface 220 and are used as descriptors and the keys, as more fully described later. It shall be noted that in this patent document the term “parameter” may mean a placeholder for a value, and it may also be used to mean the parameter values. One skilled in the art shall understand the proper meaning given the context. In embodiments, the data in the cache are key-value pairs, with each key having a corresponding value. In embodiments, the keys are used by the embedded spreadsheet engine 230 as addresses into the cache where values that will be updated to cells in the spreadsheet user interface 220 are obtained, and which values are also used by other parts of the system, including being displayed in the spreadsheet user interface 220 and in other user interfaces of the application 200.

In embodiments, each unique instrument or other data type has an array of caches, one per unique combination of any descriptor parameters, as will be shown in detail later. In embodiments, each cache is a 0-based indexed cache, which is used to store an initially fixed-length, rolling time-ordered series of data that is updated in real time, although static or other data may also be addressed and stored in the same or similar way. The length may also be extended as described later.

The data that is written into the dynamic cache 240 may be processed by a data aggregation processor 270, which performs transformations on the data primarily using aggregation or mathematical functions. The aggregation functions used by the data aggregation processor 270 may perform any kind of suitable transformation, as more fully described later, such as aggregating data into time buckets, etc. Other transformations, such as ordering the data by date-time, checking the data integrity, filling in missing data using various optional methods, re-requesting missing or corrupted data from data server 390 and any other server, and any other suitable transformations or operations on the data, may be performed. In the context of streaming data ranges as more fully described later, these data transformations may be made in real time on streams of data and/or applied to historical data returned as the results of a data query, both of which can be done concurrently to fill and update a dynamic cache.

In embodiments, for each of the data streams specified by the user, the event subscription manager 260 registers for events, such as event notices, which may include data updates, with the various data servers 390 by using connectivity adapters 280. It shall be understood that an event notice may mean a notice of an event, a notice of an event and data relating to the event, or the data related to the event in which the transmission of that data acts as the event notice. In embodiments, each connectivity adapter implements an application programming interface 290 of a particular source of data or particular execution venue, such as may be available from data servers 310 and 390, and trade execution venues, such as may be available from trading server 380. Connectivity adapters 280 may also implement an application programming interface 290 of any other desired server such as a database 370.

In embodiments, the event subscription manager 260 registers handlers/listeners for real-time data streams, and the data aggregation processor 270 processes the incoming data if necessary or desirable, such as performing aggregation on tick level data, etc. The streaming real-time data messages may also be referred to as events. In embodiments, the system is performing event stream processing as it is known to those skilled in the art. In other words, there is no data polling or bi-directional communications required to receive and process real-time data events. Unlike typical spreadsheet add-ins that pull data into the spreadsheet, the dynamic cache receives the event stream in a more efficient way. In embodiments, the event subscription manager 260 and the data aggregation processor 270 may be combined and may, together or separately, directly receive any data without the use of API 290, such as through a direct socket connection, for example.

In embodiments, the connectivity adapters 280 implement application programming interfaces 290, which may send and receive messages representing data the application 200 will process and/or display to the user for analysis or other manipulations, such as through spreadsheet formulas. These messages may be represented in any suitable format or protocol, whether standardized, such as Financial Information eXchange (FIX), or proprietary, such as simple key-value pairs. These messages may be transmitted as plain text or in binary form or other any other suitable representation over a network or networks using any suitable transport mechanism, such as HTTP or socket-based methods.

In embodiments, one or more application programming interfaces are used to obtain real-time and historical price data 300, order and position state including previous states 320, and non-price data 330 (such as status messages and other acknowledgements) from trading servers 380, data servers 390, and other servers, such as web server 400. In embodiments, the application 200 sends trading messages and other information via application programming interfaces 290 including trading messages 310, email or text message or other alerts in any suitable format 340, as well as publishing and subscribing to data through a server, such as a web server 400 or any other server for consumption by other applications including other instances of application 200, web-browser-based controls in the application Graphical User Interface 210, or other suitable consumers of the published or subscribed data. These applications receiving data or messages from application programming interface 290 may be hosted on the same workstation as the application 200 and/or on database server 360, trading server 380, data server 390, web server 400, and/or any other suitable server.

In embodiments, the application 200 connects directly and/or via application programming interfaces 290 to database 360 for user authentication. In alternative embodiments, the application may use database 360 or other databases directly or through a database server to persist user and application data, as well as to obtain real-time and historical data or any other suitable data storage and retrieval.

In embodiments, the embedded spreadsheet engine 230 processes data in the spreadsheet user interface using a standard spreadsheet processing model, such as one might find with Microsoft Excel by Microsoft Corporation of Redmond, Wash. or other commercial spreadsheet applications. In alternative embodiments, variations on these commercial spreadsheet application processing models may be used.

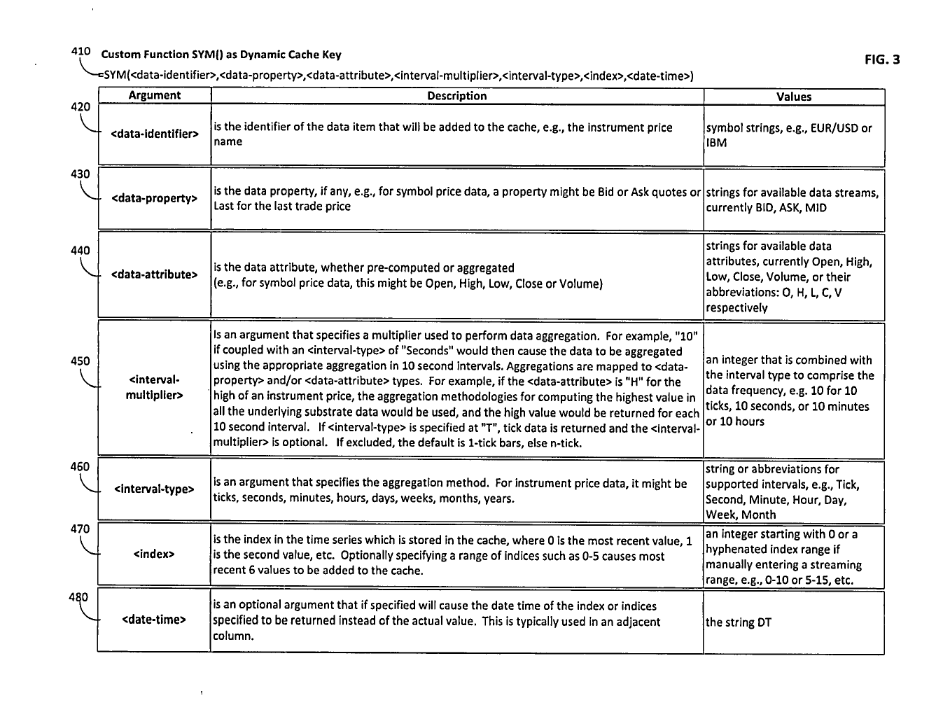

FIG. 3 is a table that illustrates a custom function, SYM( ), and its descriptor parameters, which may be concatenated together and used as dynamic cache keys, according to embodiments of the present invention. FIG. 3 depicts the custom function SYM( ) and its seven argument structure 410 according to embodiments of the present invention. In embodiments, this string of arguments is used as a key, which is created and stored in the dynamic cache's hash table if it does not already exist when it is evaluated at the time of a call to the custom function SYM( ) by the spreadsheet engine. In embodiments, each such key in the dynamic cache's hash table has a corresponding data specification (DataSpec) object, which is a map into underlying caches of data. In embodiments, caches, as described in more detail later, are themselves keyed on the symbol of a trading instrument or other data type, and the cache for each symbol contains caches for the tick-data and bar-data for the instrument. A tick represents the highest frequency data in raw form as it is produced by the source, such as the Last Traded Price or simply the Bid and Ask prices from a market maker. Tick data is typically irregularly spaced. A bar represents an aggregation of data, such as 5-minute Close bars which are the last tick (i.e., closing tick) occurring within a 5-minute interval. Bar data is typically regularly spaced except for special types such as n-tick bars which represent aggregations of some specified number of ticks which can be irregularly spaced, for example, the 50-Tick Close which is the last tick in an interval containing the last 50 ticks. Many other forms of tick and bar data exist or may be computed. In embodiments, there is one cache for the symbol's ticks, and a cache for each type of bar specified (e.g., 10 minutes, 1 hour, etc.). In embodiments, each cache has the length of the maximum number of periods specified, i.e., the latest 10 ticks or bars would be indexes 0-9. In embodiments, each cache has a parallel array of DateTime values per period.

In embodiments, the first argument in the SYM( ) function formula key is a data identifier 420, which represents the identifier of the data item that will be subscribed for and added to the dynamic cache. For example, the symbol EUR/USD might be the argument value, or any other suitable alias name mapped to the token specified by the data source.

In embodiments, the second argument is the data property 430, which may further describe the data. In embodiments, the data property maps to particular data available from the source such as the Bid, Ask, Last Traded Price, computed data such as the Bid-Ask Midpoint, or any other available or computed data. In embodiments, the values Bid, Ask, Mid are presently used, where Bid and Ask data is available from the data source and Mid is a computed value comprising the averaging of Bid and Ask data values. In embodiments, the computed values are processed by functions of the data aggregation processor, as more fully described herein.

In embodiments, the third argument is the data attribute 440, which may further describe the data. In embodiments, the data attribute maps to particular data available from the source, such as the Open, High, Low, Close, or Volume, or computed data (such as Implied Volatility), or any other available data or computed data. In embodiments, the value O maps to Open, H maps to High, L maps to Low, C maps to Close and V maps to Volume. If a data attribute is not available directly from a data source, it may be computed. One skilled in the art shall recognize this as one type of aggregation, which may be performed by the data aggregation processor using one or more functions from a library of available data processor functions, as more fully described later. For example, if the High attribute were not available, in embodiments, the High function in the data aggregation processor may process a frequency that is a factor of the specified data frequency and record and return the maximum (high) value observed for each time interval. In embodiments, in the case of the 0^{th} index in the dynamic cache, this form of aggregation may be performed in real time, in which the current value is computed and stored in memory in the dynamic cache memory address for the 0^{th} index's value. In embodiments, for other indices 1-n, the data aggregation processor may perform the calculations using historical data with the result values added to the dynamic cache.

In some cases, depending upon the data source, some of these data attributes are available directly for certain timeframes (e.g., 1 minute, 5 minute, 15 minute, etc.), while for other timeframes (e.g., 30 seconds, etc.), they must be computed from a suitable higher frequency timeframe. In embodiments, the highest timeframe is Tick data, which represents every update to a Bid or Ask price, or every traded price in the case of Last Traded Price, for example. It shall be noted that this is a second type of aggregation performed by the data aggregation processor, with the data also added to the dynamic cache as previously described. If the interval type 460 is T for tick data without the use of an interval multiplier argument for n-tick aggregations, the attribute argument 440 may be unused.

In embodiments, the fourth argument is the interval multiplier 450, which, together with the interval type 460, is either directly available from the data source and maps to an interval available for subscription, or is used as the multiplier required to perform a data aggregation, such as when an unsupported timeframe is desired. In embodiments, when the multiplier 450 is used with interval type T, an attribute argument 440 is used if more than the default 1 tick bars is desired, and a specialty aggregation function is used, which computes the attribute value for the specified number of ticks. For example, 10 tick bars with an attribute of H for the high would return the highest value of any of the ticks in each 10 tick grouping.

In embodiments, the fifth argument is the interval type 460, which specifies the frequency interval (such as tick, second, minute, hour, day, etc.). In embodiments, the specified interval may be directly available from the source and map to an interval available for subscription. In embodiments, the value T maps to Ticks, S maps to Seconds, Mi maps to Minutes, H maps to Hours, D maps to Days, W maps to Weeks, M maps to Months. If the interval type 460 is T for tick data and interval multiplier 450 is not specified, the argument data attribute 440 may not be used.

In embodiments, the sixth argument is the index range 470, which is the index range that is added to and maintained in the dynamic cache. In embodiments, the value of this argument may be either a single index value using a 0 base, where 0 means the current or most recent value, and where 1 means the previous value, etc., or a hyphenated range of values, such as 0-4, which means a time series of consecutive values from index 0, the current value, to index 4, which is the fifth value back, as more fully described later. In embodiments, when the formula contains a hyphenated range of index values, the range may be added to the dynamic cache and also displayed in a series of adjacent cells in the spreadsheet user interface.

In embodiments, the seventh argument is the date-time specifier 480, which is an optional argument that takes a value of DT, and if specified, causes the date-time of the value at each index to be returned. In embodiments, a matching formula calling SYM( ) with DT specified for <date-time> is in an adjacent cell in the spreadsheet user interface so that the corresponding date-time for each value in each time series is visible next to the value.

A list of example formulas calling SYM( ) specified in various ways is shown below:

=sym(EUR/USD,BID,T)

=sym(EUR/USD,BID,T,DT)

=sym(EUR/USD,BID,T,0)

=sym(EUR/USD,BID,T,0-5)

=sym(EUR/USD,ASK,T,3)

=sym(EUR/USD,ASK,T,1-9)

=sym(EUR/USD,BID,A,10,S,0-5)

=sym(EUR/USD,BID,O,10,S)

=sym(EUR/USD,BID,O,10,S,4)

=sym(EUR/USD,BID,O,10,S,4-8)

=sym(EUR/USD,BID,C,1,Mi)

=sym(EUR/USD,BID,C,1,Mi,0)

=sym(EUR/USD,BID,H,30,S,3)

=sym(EUR/USD,ASK,L,60,S,3-9)

Examples include data attribute T for tick data, where the interval multiplier and interval type are not specified, as well as formulas with index ranges specified and date-time specified.

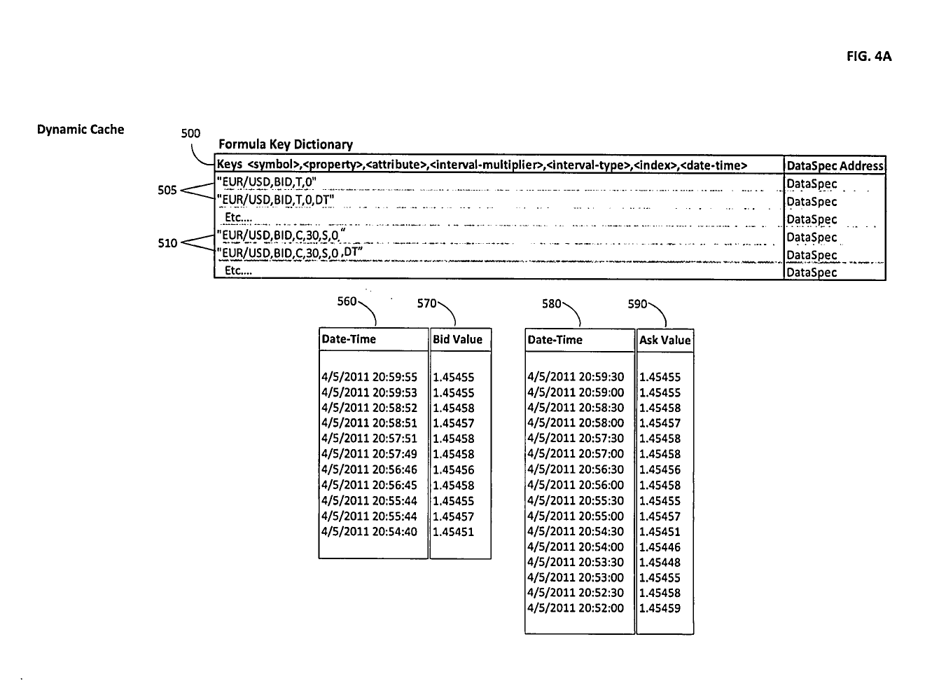

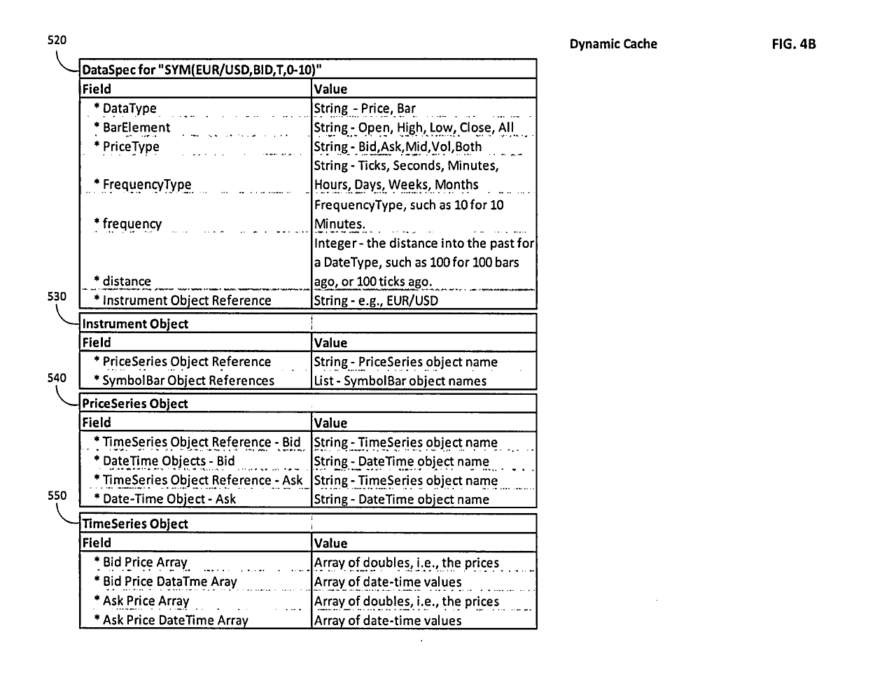

FIGS. 4A and 4B illustrate dynamic cache methodologies and data structures according to embodiments of the present invention. Referring to FIG. 4A, examples of two streaming data range formula keys with their corresponding date-time formula keys are shown at 505 and 510. In embodiments, these custom function formulas are parsed when called for the first time, and entered into the formula key dictionary 500, which is a hash table of formulas used as keys into the dynamic cache. In embodiments, the values in the dictionary 500 are keys and addresses of DataSpec objects, which refer to locations in the cache containing values used as the result-value of a cell in the spreadsheet in which the formula key resides. In other words, in embodiments, the result of the formula is a value from the cache obtained using the DataSpec for the formula key which will be updated in real time. The cache is considered dynamic because the user arbitrarily enters formulas into cells in the spreadsheet user interface using a custom function (e.g., SYM( )), which formula is parsed on the first call to the custom function and the corresponding data cache is automatically created and data subscriptions registered. In embodiments, the cache is also re-created for these formulas when the application loads. In embodiments, the custom function SYM( ) may be parsed by a cache manager module (not shown). When SYM( )-based formulas are removed, the cache manager may remove the keys from the formula key dictionary and clear the cache of those keys and their values.

In embodiments, when a new formula key is added to the dictionary 500, a hierarchal series of objects are created, comprising the cache. Each formula using custom function SYM( ) is a key to retrieve the top-level object called the data specification object 520 (FIG. 4B), which is a map of the caches. In embodiments, the data specification object 520 (FIG. 4B) comprises these key elements:
DataType
   Price
   Bar
BarElement
   Open
   High
   Low
   Close
   All
PriceType
   Bid
   Ask
   Mid
   Vol
   Both
FrequencyType
   Ticks
   Seconds
   Minutes
   Hours
   Days
   Weeks
   Months
There are two integers for the following parameters: FrequencyMultiplier—the number that goes with FrequencyType, e.g., 10 for 10 Minutes
Distance—the distance into the past for a DataType, such as 100 for 100 bars ago or 100 ticks ago

In embodiments, there is also a reference to the next object, the instrument object 530. An instance of an instrument object is a PriceSeries class specialization, which is a tick series. It also may have a list of SymbolBar objects, which are various bar configurations for the symbol data comprising data specification parameters 520, as illustrated above. In embodiments, SymbolBar objects are added to an instrument object on an as-needed basis. It shall be noted that any other objects or data may be added to the dynamic cache to accommodate any other data needs.

In embodiments, there is a dictionary of instrument objects keyed on a symbol. In embodiments, this is the top level of the cache of data, which a data specification 520 is a map into. Consider the following embodiments provided by way of illustration. If a data specification refers to a tick data series, the InstrumentObject for that symbol is used as the PriceSeries. If the data specification refers to a bar series, it will look up the specified SymbolBar to get the PriceSeries for that bar. The key to look up a SymbolBar is the combination of the PriceType, FrequencyType and FrequencyMultiplier parameter. The Distance parameter is the index into the PriceSeries, which is a zero-based index. In embodiments, there is one InstrumentObject per symbol, and all data specification objects share it. Each data specification has a Distance parameter, and the PriceSeries for any bars or the tick series for the InstrumentObject grows to the maximum distance needed for all data specification objects that refer to it.

In embodiments, a PriceSeries 540 is two TimeSeries objects 550, one for Bid prices and one for Ask prices. In embodiments, a TimeSeries object may be two arrays of values, which are the prices, 570 and 590, and a corresponding parallel array of DateTime series 560 and 580 respectively. PriceSeries objects may also have a Distance parameter, but in this case, it means the maximum periods. In embodiments, TimeSeries objects use a MoveForward function for moving the values forward to the next cell when a time interval ends, or in the case of tick data, when a new tick event arrives. In addition, an Extend function may be used for extending the TimeSeries and DateTime arrays when the number of intervals needed (the Distance parameter) increases, such as through the addition of one or more SYM( ) functions with an index beyond the existing cache indices.

By way of illustration, the example keys 505 and 510 shown in FIG. 4A cause the objects 520, 530, 540, 550 and 560, 570, 580 590 to be created. The first key at 505 specifies tick data for the 0 index, and the second key at 505 specifies the corresponding tick's date-time for the 0 index (for brevity keys for indices 1-10 for the tick data are not shown in the dictionary). The corresponding TimeSeries cache of data for the first key at 505 is shown at 570 (indices 0-10 are shown here), and the DateTime cache for the second key at 505 is shown at 560 (indices 0-10 are shown here). It can be seen that the date-time values are irregularly spaced, as is typical for tick data, although it should be noted that aspects of the present invention may be used with regularly or irregularly spaced data.

The first key at 510 specifies 30 second bars of data for the 0 index and the second key at 510 specifies the corresponding tick's date-time for the 0 index (for brevity keys for indices 1-15 for the 30 second bar data are not shown in the dictionary). The corresponding TimeSeries cache of data for the first key at 510 is shown at 580 (indices 0-15 are shown here) and the DateTime cache for the second key at 510 is shown at 570 (indices 0-15 are shown here). It can be seen that in the depicted example that the date-time values are regularly spaced, as is typical for aggregated bar data but not required.

The second keys at 505 and 510 show an example of the arguments to the SYM( ) formula corresponding to the DateTime series, where the arguments match the formulas corresponding to the TimeSeries. But, in addition to the index value as the final argument, another argument containing the string DT may be used to indicate that the value from the corresponding DateTime series should be returned to that cell.

An aspect of embodiments of the present invention is the creation and maintenance of a time series of data where the 0 index is the very latest value and the index range represents a rolling window of time comprised of the specified data, tick or specified interval such that the values older than the end of the index range fall off, or are replaced continuously. This allows for formulas in the spreadsheet interface to process time series data in real time. These time series are also known as streaming data ranges. In embodiments, a feature of a streaming data range is that the 0^{th} index value, which is the current time interval being aggregated, is populated with real-time data updates of the value of the aggregation type specified in the formula key using tick data, which is the highest frequency data update available.

For example, the formula key =SYM(EUR/USD,BID,C,30,S,0 specifies 30-second intervals of the Bid price's Close value. All indexes greater than 0 will return the Close value of the respective 30 second interval, or time bucket, which corresponds to the last tick of the Bid price within each respective time bucket. In embodiments, this is a definition of the Close aggregation function. The 0^{th} index however, will be updated in real time with each tick for the Bid during the currently elapsing time interval. This allows trading strategies to generate signals that are intra-bar, as it is commonly known to those skilled in the art. For example, in a trading strategy that is monitoring prices for a breach beyond a certain price level, the Close values of a particular frequency of data are typically used in the model. It can be critical to be able to act on the price breach event in real time as the breach occurs rather than waiting for a Close value of the current time interval to see if it has breached the price level.

To illustrate further, imagine a trading strategy model that uses a streaming data range of 15-minute intervals as the basis for the model. Assume further that the model was to trigger a Sell trade when the price breaches 2 standard deviations above the mean over the range length. If the breach occurred in the first 5 seconds of the current 15-minute interval, the trade would not be triggered in a timely manner if the price update for the current interval could not be accessed until after the interval had concluded. In fact, if the aggregation type specified for the price data was Close, which is the last price update that is still within the time interval (as opposed to the High which would record the highest price update seen within the interval), the event could be missed altogether because the Close value may be lower than the price level where the breach occurred.

In the case of a streaming data range that is all tick data, the 0^{th} index is the latest tick, and each new tick causes a move forward. In alternative embodiments, the 0^{th} index may be updated at any other sub-interval that is suitable, such as 500 millisecond, or 1 second updates.

In embodiments, historical data is not stored in the dynamic cache, except for historical data that is part of a range of streaming data when the dynamic caches are initialized with historical data. In embodiments, historical data populating indices greater than the 0^{th} index in a streaming data range is stored in the cache. As the values are moved forward at the conclusion of each time interval, the SYM( ) function is present in each cell and is the key into the cache, and the value in the cache is read in and returned to the cell. In embodiments, static historical data is stored as data directly in the spreadsheet cells, and is not stored in the cache—although static historical data may be stored in the cache and similarly accessed with SYM( ) or another function. In embodiments, the current and historical state for any order, position, or other supported state variables (such as summary values like Net Profit/Loss) are also added to the dynamic cache when specified by the inclusion of a formula that accesses state. For example, the following formula specifies the current value (0^{th} index) of the net profit/loss for open buy trades in the EUR/USD:

=POS(“<account>”,“EU/VUSD”,“BuyNetPL”,0)

The above formula creates a cache for this state value in the dynamic cache in the same way that =SYM( ) does for other real-time data.

In embodiments, the state is initialized for the 0^{th} index (current time interval) either with requests for state data obtained from the trading or data or other server, with new events that update the state values, or in the case of state values that are computed by the system itself, with newly computed state values, or a combination of all these methods in some cases.

In embodiments, historical values of state (indices 1-n) are initialized with requests for historical state data obtained from the trading or data or other server, or with data serialized with the application, or with state data that was persisted to a database, or a combination of all these methods in some cases.

In alternative embodiments, the current and/or historical state values are filled with state value update events and/or values computed by the system since the application was loaded. In other words, it is constructed on the fly in real time based upon actual state changes that are observed, with the historical indices filled over time.

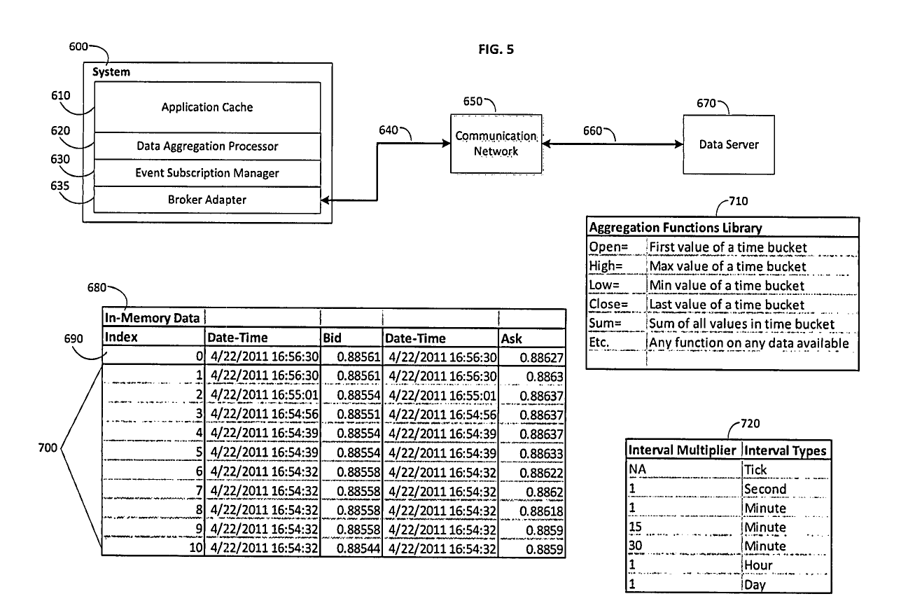

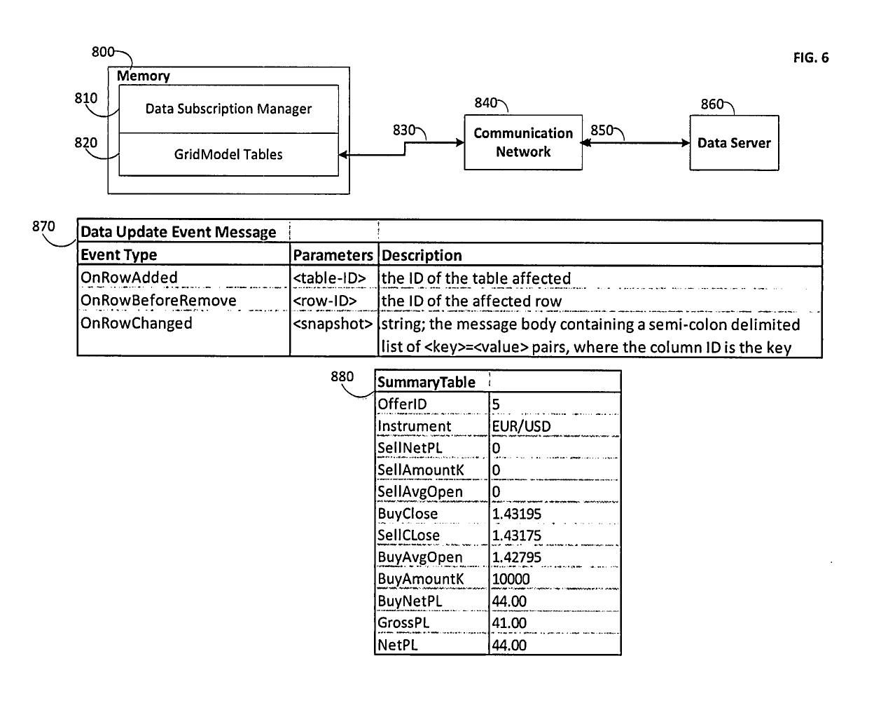

FIG. 5 illustrates data aggregation according to embodiments of the present invention. Referring to FIG. 5, in embodiments, the data aggregation processor 620 is shown as a module running in system 600 and processes streams of data returned via a broker adapter 635 in order to perform two different types of aggregation. In embodiments, the data aggregation method may be running in process or may be distributed.

In embodiments, broker adapters 635 connect to Data servers 670 through a communication network 650 using communication links 640 and 660. These data servers 670 typically support a fixed number of pre-determined data frequencies, which are defined by interval multiplier and interval type combinations. In the depicted embodiment, table 720 stores the available base interval multipliers and interval types that the data server has available pre-aggregated. Embodiments of the present invention eliminate limitations to already available frequencies by incorporating a data aggregation processor for composing bars from other bars or from the highest frequency data type, ticks.

The first type of aggregation is referred to as bar aggregation, which is the creation of lower frequency bars, as they are commonly known to those skilled in the art, from higher frequency data bars or ticks. For example, composition of 10-minute frequency bars of data from 1-minute frequency bars of data, or composition of 90-second frequency bars from ticks.

This type of aggregation may be used for processing historical data both for initializing streaming data ranges that continuously read their current values from the dynamic cache using the SYM( ) based formula and key, as previously described, and for static historical data that is placed directly into the spreadsheet as numbers or date values. In embodiments, in both cases, once the data values are added to the dynamic cache or the spreadsheet cells, this data is no longer associated with underlying memory previously occupied during retrieval and aggregation, if any.

In embodiments, initialization of the 0 index for a partially elapsed time interval is handled in the same way, but updated using tick data thereafter once caught up to the current time corresponding to new incoming tick data events, as described in more detail later. In embodiments, the initialization of a streaming data range with historical data is automated at the time the series is created within the cache.

In embodiments, for bar aggregation, logic determines if aggregation is required and other logic sets a group of variables for the type of aggregation required. Based on the desired aggregation, the interval type and interval multiplier parameters as well as start and end parameters and other information is used to aggregate higher frequency data into the desired frequency. A simplified example of the aggregation logic is shown as follows:

### Aggregation Logic

Given a SYM( ) key: =sym(EUR/USD,BID,H,10,S,0)
Parse formula: interval multiplier=10 interval type=second
Check for availability of 10 second; false
Find nearest factor of 10 second; 1 second
Perform aggregation on the 1 second data
   get historical 1 second data, aggregate to 10 second data and add to historical indexes 1-n in cache to initialize
   start collecting current ticks for Bid High for 0 index
   get historical ticks for current time interval of 0 index start date-time to current date-time, merge together with new incoming ticks at intersection of current date-time
   When the interval is closed, move the value down in the cache to the next index
Begin computation for 0th index for next current time interval using tick data

In embodiments, the second type of aggregation is referred to as property/attribute aggregation, which is performing an operation on the price and or other data to capture certain characteristics of the data (e.g., the middle value of the Bid-Ask price spread, the high price value of the time interval, or any other suitable data processing function). In embodiments, both the historical data processing and the O-index real-time data processing may undergo both forms of aggregation concurrently. For example, tick data for the Bid and Ask may be processed to form the Mid price while also being processed to capture the high (max value), resulting in the Mid property and High attribute.

It shall be noted that, in embodiments, the aggregation functions are event stream processors, capable of performing aggregation on streaming regularly or irregularly spaced tick data. By being capable of processing tick level data, virtually any other frequency of data can be created and virtually any defined characteristic of the data can be captured.

In embodiments, both forms of aggregation may be performed concurrently, such as processing 1-minute high bars into 10-minute high bars while recording the highest value in the ten 1-minute bars processed. In embodiments, these aggregation methods could be performed in a separate server-side module implemented in software, hardware, or a combination thereof for enhanced scalability, with data streamed to system 600 or written to a shared storage medium.

In embodiments, for real-time data aggregation, the data aggregation processor 620 uses the dynamic cache as previously described, except that the output of processing the tick data with the library of aggregation functions 710 is stored in the dynamic cache for the current time interval in the 0-index slot as shown at in 680 for 690. When a time interval completes, the final state of the value is pushed downward sequentially in the time series window in the cache, as illustrated with 690 and index 1 in 700. Note that this illustration is a snapshot in time—at the instant the time interval completes and the values are shifted down in the cache, the new time interval is displayed for the 0 index and the aggregation of data begins with all new incoming data update events, which current aggregation value is displayed for the 0 index. For example, in the case of 30-second frequency bars starting at 12:00:00 AM, the 0 index is updating in real time with the latest value that the aggregation function returns with each new data update event from 12:00:00 to 12:00:30. At 12:00:30, the value at index 0 becomes a fixed value that is pushed to index position 1 in the cache, while at the same time the O-index value represents the newly started time interval, 12:00:30 to 12:01:00. Likewise, the value at index 1 is pushed to index 2 in the cache, so forth for each index except the last index in the cache which is replaced with the value from the next-to-last index.

In embodiments, the event subscription manager 630 uses standard C#/Java style event mechanisms (although one skilled in the art shall recognize that other coding may be used) for price and other data and for trading-related events. In embodiments, code throughout the system can register for published events, such as new prices coming in via the system APIs. For example, an open order ticket dialog may subscribe to a price updated event and check for changes relevant to the order in the GUI. Also, in embodiments, price events may be monitored by the cache manager code, and symbols and their dynamic caches will be updated accordingly. In embodiments, another event type may be table updates, which monitor updates to other data, such as orders and trades. In embodiments, the incoming events are repackaged or normalized and broadcast to registered listeners.

FIG. 6 illustrates in-memory data tables objects according to embodiments of the present invention. Referring to FIG. 6, events for real-time data updates used throughout the system may be subscribed for, and messages containing updated values may be updated to in-memory 800 table objects called a GridModel 820. In embodiments, the GridModel table object is instantiated for each unique table. Tables may be created for any logically grouped data-set, such as bid and ask quotes, open trades, closed trades, or any other suitable purpose. Or, they may be combined into a single table or otherwise organized using any suitable data structure.

In embodiments, the GridModel represents a generic interface to any available update events and any message format, whether proprietary or standardized, from any suitable data source. In embodiments, the events are efficient and contain only the values that change, which are mapped into a GridModel table ID, column ID, row ID, and the new value itself—although it shall be noted that any suitable message format and content may be processed for purposes of updating the GridModel. In the event that the incoming messages are not efficiently represented, the values in the GridModel tables may be updated only if the values have changed. Additionally, in embodiments, extra data that is not represented in the GridModel as required by the system may be discarded rather than be included, thereby minimizing the GridModel size.

In embodiments, the data subscription manager 810 handles processing of incoming events and updating the GridModel table objects. An example of a data update event message is shown at 870. The table ID, row ID, and message body containing a string of column ID=value pairs are included in this particular message example. Any suitable message format may be processed and used to update the GridModel table objects.

In embodiments, there are multiple instances of the GridModel table objects. In embodiments, one instance of the GridModel tables is used for internal application logic, such as custom function processing, so that these tables may be locked for performing calculations and other data processing where it is important that transactional processing of the data is maintained without data changing during the processing. In addition, the tables that support the custom functions processing are generally much smaller and have much higher frequency updates, so maintaining a separate instance of the GridModel to support them is generally more efficient. In embodiments, the instance of GridModel tables that support custom functions have a minimum set of required columns that can be thought of as system columns, which are used for the custom functions to operate. It shall be noted that other arbitrary columns may be added to support new custom functions or other system requirements.

In embodiments, a second instance of the GridModel tables exists to provide data for updating user interface where throttling of the updates or other processing requirements differ from the transactional processing of the data used by custom functions or other parts of the system. In embodiments, a temporary instance of a GridModel may be created to support temporary user interfaces, such as certain pop-up dialogs. These tables may be thought of as display tables. They maintain efficiency by using only the columns specified for display in the user interface or required by a particular display type and optionally through lower frequency updates.

In both the system tables and display tables, there may be computed columns, which is data derived from incoming real-time data messages and/or other data sources. These data are used to support custom functions or other parts of the system, and/or to expand the displayed data. In embodiments, other hidden columns for supporting the system may also be added that may be populated with data from computed columns and/or other data or system processing output.

In embodiments, the following tables related to trading data may be used:
Accounts table—keeps data about trading accounts, such as type and permissions.
Orders table—keeps data about orders which are placed from the account for the instruments. In embodiments, the data about orders are kept in the Orders table until they are executed.
Trades table—keeps data about open positions.
Closed Trades table—keeps data about closed positions.
Summary table—keeps the summarized data about all positions opened in each traded instrument.
Messages table—keeps data about the messages sent by the trading server or other trade messaging system.

Any or all of these tables may be combined into one or more GridModel objects, as deemed suitable for a particular use case. Other data structures for making real-time data updates available to the system may also be used. Real-time price updates are received in real time as events (as previously described); however, in alternative embodiment, real-time data update events may be used to populate a table or GridModel object.

An example of the Summary Table is shown 880. The data in the GridModel object may be used by custom functions, such as SYM( ) (previously discussed) and TRD( ) (discussed below), or some or all of the data may be reflected in user interface grids or other displays that update in real time.

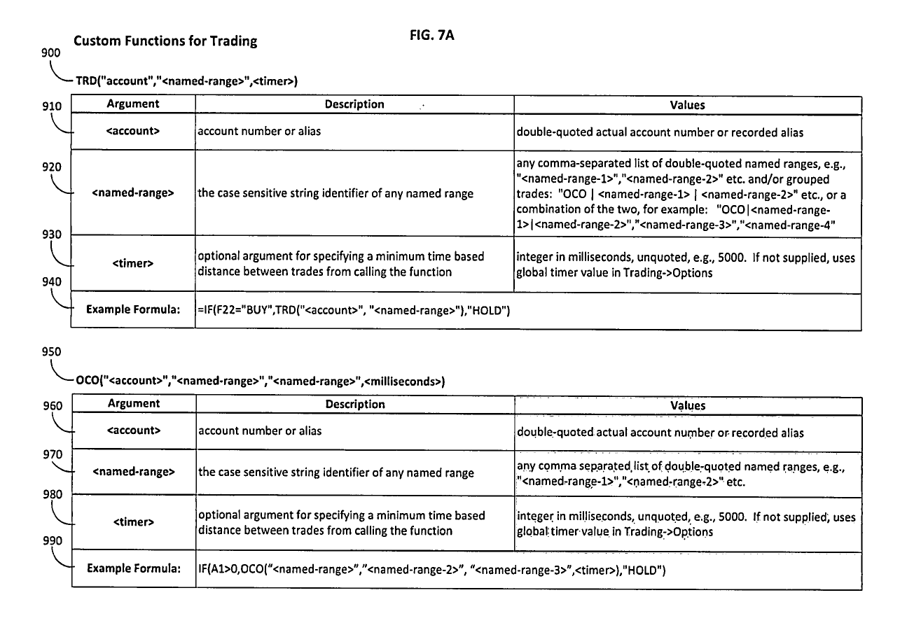

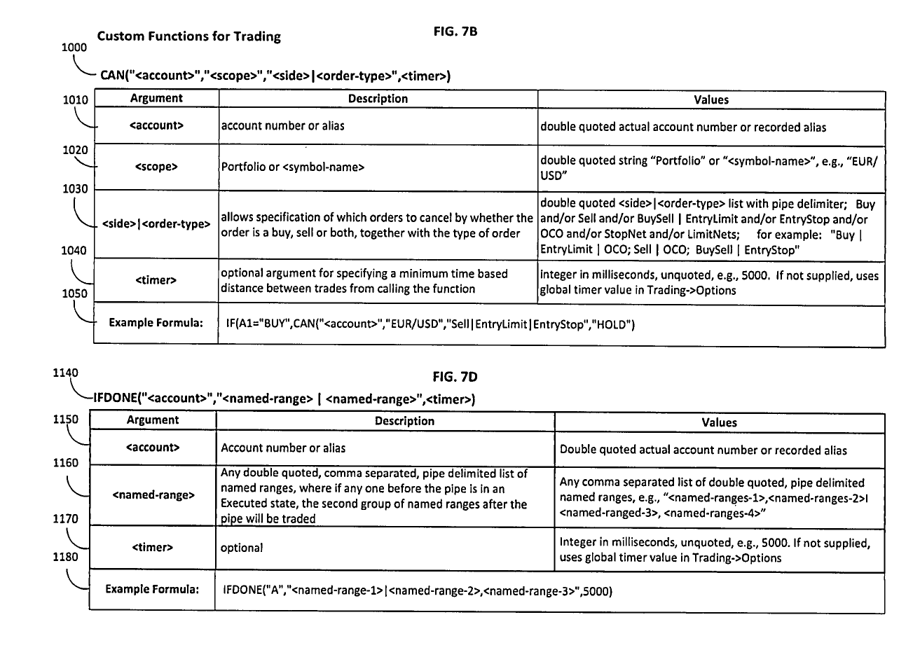

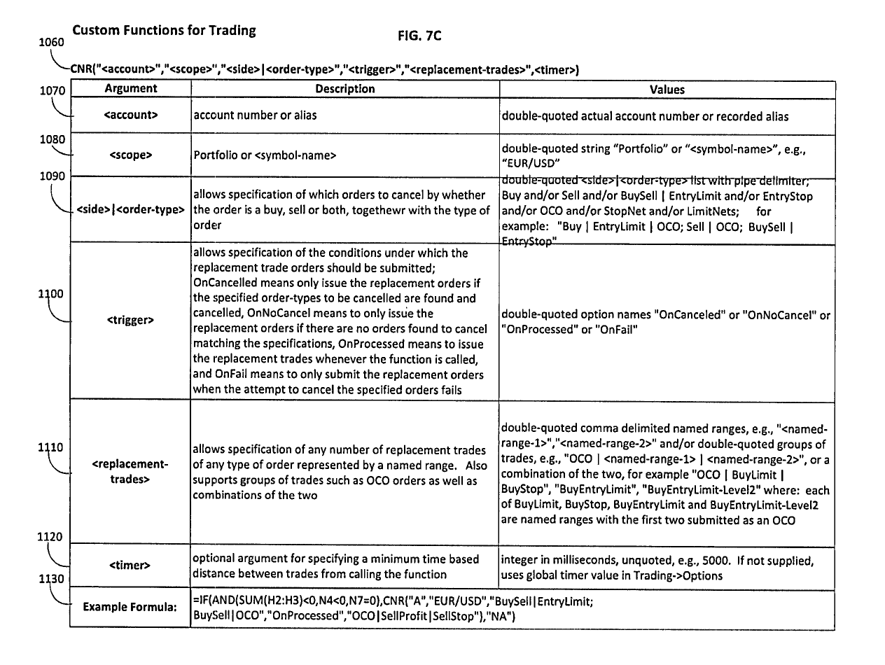

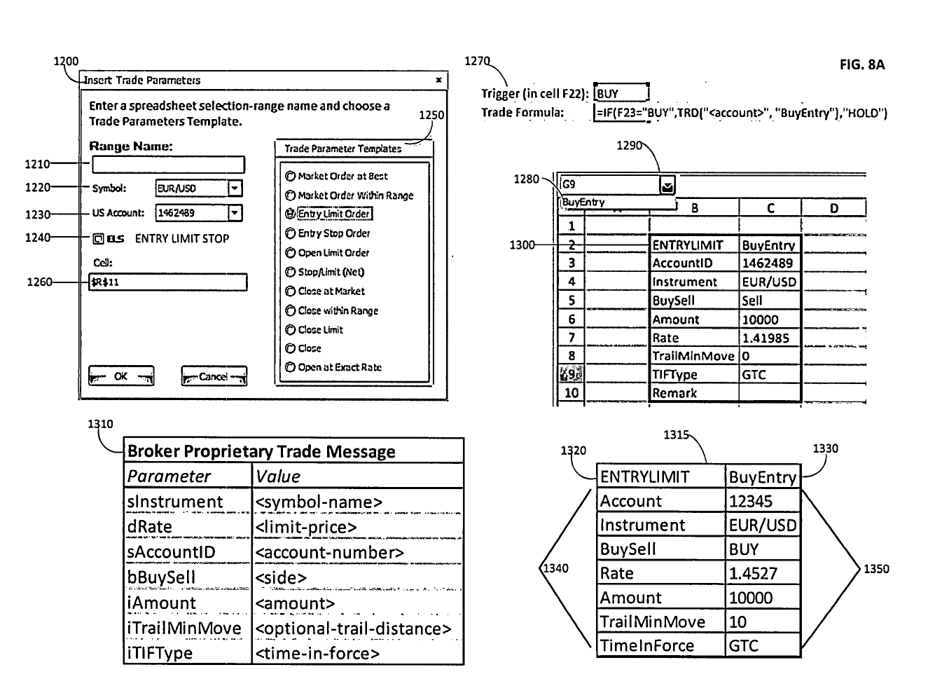

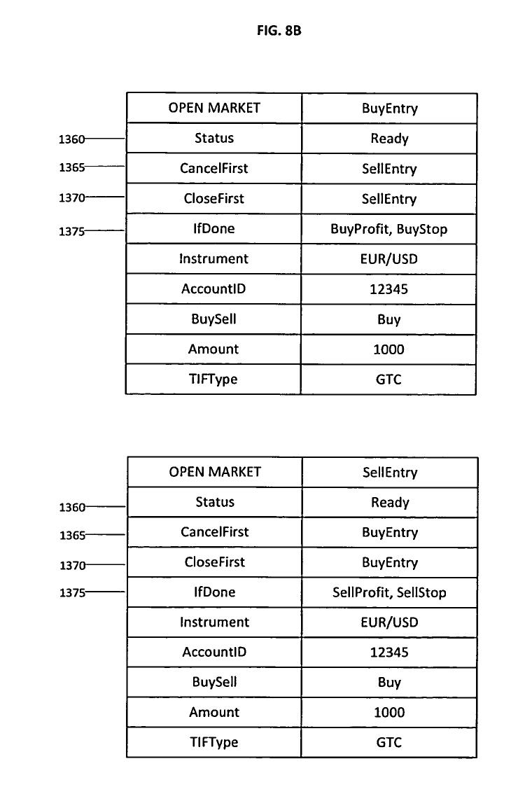

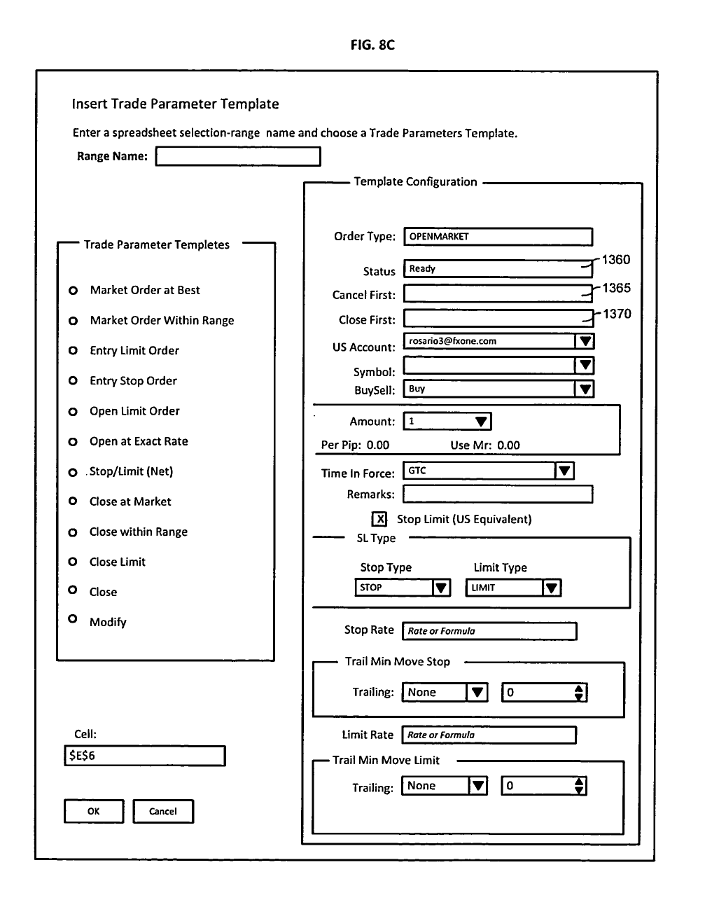

FIGS. 7A, 7B, 7C, and 7D together illustrate a table of the trading custom functions according to embodiments of the present invention. Referring to FIGS. 7A-D, the table contains five custom functions that are used to perform trading operations, TRD( ), OCO( ), CAN( ), CNR( ), and IFDONE( ). It shall be noted that these functions may reference one or more named ranges. The named-range trading according to embodiments of the present invention is more fully described below. Additionally, it shall also be noted that each trading custom function may be nested anywhere within ordinary spreadsheet formula logic. For example:

=IF(F22=“BUY”,TRD(“<account>”, “<named-range>”),“HOLD”)
is a standard IF(test, if true, if false) expression familiar to any spreadsheet user, where TRD( ) is called if true, as shown at 940.

In embodiments, the first trading function, TRD( ) 900, comprises three arguments. The first argument is the <account> 910, which can be an alias assigned by the user or the full account number. Specifying the account argument in each instance of TRD( ) provides support for trading in multiple accounts at one or more brokers from a single instance of the present invention.

In embodiments, the second argument is the <named-range> 920, which may be any comma-separated list of double-quoted named ranges, as shown. In embodiments, each named range that is listed becomes a unique trading message that is generated and routed to the trading server or other suitable recipient. A named range in a spreadsheet is generally any one- or two-dimensional array of cells that are selected and given a name by which formulas can then reference by name as an array or as a table, instead of explicitly referencing the column and row coordinates. In embodiments, named ranges are used to hold sets of key-value pairs related to parameterizing a trading message, as will be more fully described later. Other key-value pairs or data may also be held in named ranges for reference by custom functions or other parts of the system.

In embodiments, groups of pipe delimited named ranges may also be specified as shown at 920 in the values column. For example, the token OCO is used to indicate that the named ranges that follow in the group are to be submitted to the trading server as a particular type of order and/or using a particular order submission method or format. OCO in this example means One Cancels Other, which is a common order type known to those skilled in the art. In alternative embodiments, other tokens for grouping named ranges under a parent order or for any other suitable purpose may be added.

In embodiments, the last argument of TRD( ) is an optional <timer> 930, which may be an unquoted integer that represents the number of milliseconds that must elapse prior to allowing the particular instance of TRD( ) to generate a trade message after a previous call to TRD( ). If the timer has not elapsed and the TRD( ) function is called again as the spreadsheet formula is recalculated, the call to TRD( ) will be ignored and logged. In embodiments, the timer argument is an override of the global timer variable control, which may be accessed by a user via a trading-related options user interface. If the argument is missing within a particular instance of TRD( ), a global default value may be used. Both the global variable for trading function timers and the local timer argument may be set to zero, indicating no timer will be enforced and back-to-back calls to TRD( ) may be performed. An example of TRD( ) used within a spreadsheet formula is shown at 940.

In embodiments, the second trading function, OCO( ) 950, has the same three arguments 960, 970 and 980 as TRD( ) 900, which also operate in the same way as previously described with respect to TRD( ). In embodiments, the difference between TRD( ) 900 and OCO( ) 950 is that OCO( ) generates a special parent order type called One Cancels Other that has any number of child orders that can be of any contingent order type. Those skilled in the art understand that when any one child order is filled in an OCO order, all other child orders are automatically cancelled. An example of OCO( ) used within a spreadsheet formula is shown at 990.

In embodiments, the third trading function, CAN( ) 1000, is used to cancel existing orders and has four arguments. The first argument <account> 1010 functions in the same way as previously described for the other trading functions.

In embodiments, the second argument, <scope> 1020, takes a double-quoted string that is either “Portfolio,” which indicates that the CAN( ) function is to be applied across orders for all instruments, or it can take a specific symbol for an instrument, e.g., “EUR/USD” for a EUR/USD FX pair.

In embodiments, the third argument, <side|order-type> 1030, allows specification of which orders to cancel by whether the order is a Buy, Sell, or either, together with the specific order type. For example, if “Buy|EntryLimit|EntryStop” were specified in this argument and <scope> was “EUR/USD,” a call to CAN( ) would cause the underlying logic to loop through all orders to find those that are: (1) an order for EUR/USD, (2) a Buy order, and (3) either an EntryLimit- or EntryStop-type order, and would cancel those that meet these criteria. In embodiments, semi-colon delimited groups of <side|order-type> arguments may be used within the double quoted argument value to cancel orders using differing criterion. For example, “Buy|EntryLimit; Sell|OCO” would cancel orders for the whole portfolio or the specified symbol that are either Buy orders of type EntryLimit, as well as any order of type OCO that contains a Sell order.

In embodiments, the last argument to CAN( ) is an optional <timer> 1040 argument that functions as it does for other trading functions, as previously described. An example of CAN( ) used within a spreadsheet formula is shown at 1050.

In embodiments, the fourth trading function, CNR( ) 1060, is used to cancel existing orders and replace them with new orders. The first three arguments, <account> 1070, <scope> 1080, and <side|order-type> 1090 operate in the same way as for CAN( ) 1000, as previously described. In embodiments, CNR( ) 1060 has two additional arguments.

In embodiments, the fourth argument, <trigger> 1100, is used to specify the conditions under which the replacement orders will be submitted. Different double quoted states may be specified as this argument value. In embodiments, “OnCancelled” means issue the replacement orders only if the specified order-types to be cancelled are found and cancelled; “OnNoCancel” means to issue the replacement orders only if there are no orders found to cancel matching the specifications; “OnProcessed” means to issue the replacement trades whenever the function CNR( ) 1060 is called; and “OnFail” means to submit the replacement orders when the attempt to cancel the specified orders fails.

In embodiments, the fifth argument, <replacement-trades> 1110, allows the specification of any number of replacement orders of any type represented by one or more named ranges and/or group of named ranges as previously described. For example, “<named-range-1>, <named-range-2>; OCO|<named-range-3>|<named-range-4>” would generate trade order messages for the named ranges 1 and 2 and an OCO parent order containing named range 3 and 4 to replace the canceled orders.

In embodiments, the last argument to CNR( ) is an optional <timer> 1120 that operates as it does for other trading functions as previously described. An example of CNR( ) used within a spreadsheet formula is shown at 1130.

In embodiments, the fifth trading function, IFDONE( ) 1140, comprises three arguments. The first argument is the <account> 1150, which can be an alias assigned by the user or the full account number. Specifying the account argument in each instance of IFDONE( ) provides support for trading in multiple accounts at one or more brokers from a single instance of the present invention.

In embodiments, the second argument is the <named-ranges-to-check|named-ranges-to-do> 1160, which may be any comma-separated list of double-quoted named range trading parameter templates (which may be referred to herein for sake of brevity as named ranges) a user may wish to check the status of to determine if they were executed (the test to see if they were done), then a pipe separator followed by any comma-separated list of double-quoted named ranges a user desires to trade if any of the previous orders were executed (i.e., if done test), as shown. In embodiments, each named range that is listed after the pipe delimiter becomes a unique trading message that is generated and routed to the trading server or other suitable recipient. In embodiments, a named range trading parameter template in a spreadsheet is generally any collection of cells (such as any n-dimensional array of cells) that are selected and given a name by which formulas may then reference by name as an array or as a table, instead of explicitly referencing the column and row coordinates. In embodiments, named ranges are used to hold sets of key-value pairs related to parameterizing a trading message, as will be more fully described later. Other key-value pairs or data may also be held in named ranges for reference by custom functions or other parts of the system.

In embodiments, groups of pipe delimited named ranges may also be specified as shown at 1160 in the values column. For example, the second argument to IFDONE( ) can be a comma-separated list of double quoted <named-ranges-to-check|named-ranges-to-do> groupings, each of which may be one-to-one, one-to-many, many-to-many or many-to-one with respect to the named ranges that that are being checked and the named ranges that are being converted into trade messages and sent to a trading server. In alternative embodiments, other tokens for grouping named ranges under a parent order or for any other suitable purpose may be added.

In embodiments, the last argument of IFDONE( ) is an optional <timer> 1170, which may be an unquoted integer that represents the number of milliseconds that must elapse prior to allowing the particular instance of IFDONE( ) to generate a trade message after a previous call to IFDONE( ). If the timer has not elapsed and the IFDONE( ) function is called again as the spreadsheet formula is recalculated, the call to IFDONE( ) will be ignored and logged. In embodiments, the timer argument is an override of the global timer variable control, which may be accessed by a user via a trading-related options user interface. If the argument is missing within a particular instance of IFDONE( ), a global default value may be used. Both the global variable for trading function timers and the local timer argument may be set to zero, indicating no timer will be enforced and back-to-back calls to IFDONE( ) may be performed. An example of IFDONE( ) used within a spreadsheet formula is shown at 1180.

In embodiments, the trading functions generate trade messages sent to a trading server. In alternative embodiments, the application (e.g., application 200) or some other suitable intermediary server or application may perform the order management function normally performed by the broker's trading server and execute certain trades using immediate order types, such as market orders. In this case, calls to trading functions might affect the internal order state only instead of generating and transmitting a trading message.

In embodiments, the functions may also explicitly contain all of the parameters so that the same operations may be performed and specified entirely within the spreadsheet formula without the necessity of a named range. Any suitable trading or other type of operation may be added and processed in the same or similar way.

In embodiments, the trading custom functions may have an optional argument for specifying strategy identifier tags that may be captured and associated with orders and positions in the state cache that trading strategies and other logic can be developed around. For example, feedback loop custom functions may filter on these tags by using an optional argument for such tags.

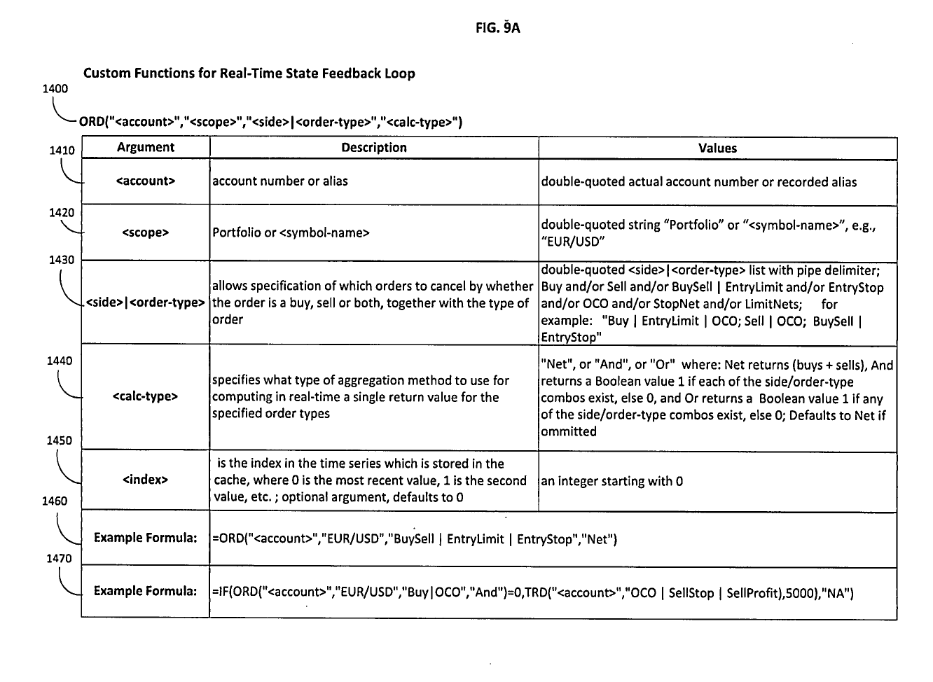

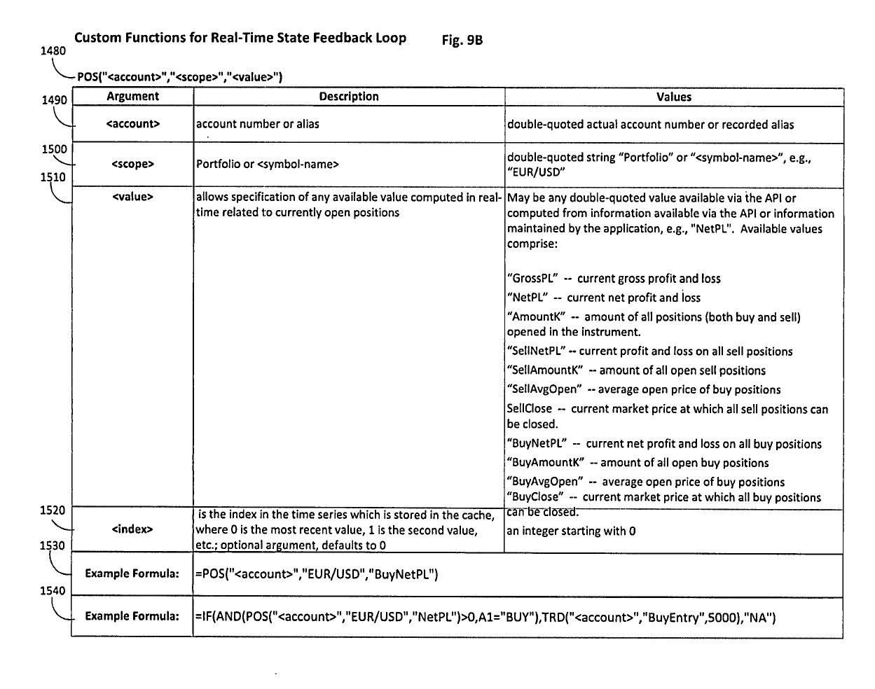

FIGS. 8A-C illustrate embodiments of named-range trading according to embodiments of the present invention. Referring to FIG. 8A, an application with the embedded spreadsheet engine has a unique user interface 1200 that facilitates creation of named ranges and specification of the order type and certain trading template parameters. In embodiments, the interface may present the following user choices:
1. Field for entry of the named-range name 1210
2. Automatically populated dropdown menu for selection of the tradable instrument symbol that will be added to the template 1220
3. Automatically populated dropdown menu for selection of the account identifier that will be added to the template 1230
4. Checkbox for adding/removing Stop and Limit order parameters (or their equivalent for FIFO regulated accounts) to the template 1240
5. Automatically populated list of trade templates available via the broker interfaces in the particular instance of the application 1250 and a selector mechanism such as radio buttons
6. A display showing the cell coordinates where the template will be added to the spreadsheet user interface based on the currently selected cell, with the ability to change the starting point for the creation of the named range by clicking in a different cell in the spreadsheet user interface 1260

In embodiments, the trade template selection interface 1200, when completed by a user and submitted, will cause a named range to be created in the spreadsheet user interface and will be visible in the named range dropdown menu 1280 and 1290 and in the spreadsheet user interface worksheet 1300. In embodiments, these named ranges contain the information that comprises a full specification for a trading message, and the named-range name becomes the identifier for the particular trading message that can then be referenced inside trading custom functions as previously described in detail. Any other suitable information, selections, parameters, or settings may be added to the user interface and to the named-range templates, including for other usages. One skilled in the art shall recognize that other forms of message enrichment may be added at the template level, becoming part of the messages.

In embodiments, the contents of the cells in the named range 1315 based trade order template are automatically added and displayed in the spreadsheet user interface 1300 when created. The key-value pairs contained in each row of the named range map to key-value pairs in a broker-specified trade message 1310 for the broker interfaces that are implemented within the system. The broker trade order messages typically have a key-value structure, whether they use a proprietary protocol as illustrated by 1310 or an industry-standard trade order message protocol such as FIX, as is familiar to those skilled in the art. One skilled in the art shall recognize that any order type may be mapped into a named range using the same or similar methods.

In embodiments, the named range is a two-dimensional array with two columns used. The first column starts with the order type 1320, followed by the keys or names of the parameters 1340, and the second column starts with the named-range name 1330 followed by the default value or a textual indication of the permissible value 1350. One skilled in the art shall recognize that other configurations may be used.

In embodiments, the key names in the first column are logically ordered and aliased with user-friendly, readable key names as can be seen by comparing the first column in the broker message 1310 with 1340. For example, “sInstrument” becomes simply “Instrument”.

Because the cells containing values for the parameters are typical spreadsheet user interface cells, they can contain formulas that generate the values that will be used in the trade order message besides static data. This means that values, such as the Rate or the Amount or the Stop Rate and Limit Rate, may be dynamically calculated in real time based upon data or formulas in other cells. For example, the Amount field may have a formula that references a cell that contains a formula that calls a real-time feedback loop function that updates with the current day's profit/loss value, and could return a different amount value depending upon the profit/loss, perhaps decreasing the amount of each trade to reduce risk if the account shows a current loss. Similarly, Stop and Limit rates may be modified based upon real-time market conditions, such as the volatility over the last n periods.

In embodiments, named-range trading parameter templates have the order type specified in the upper left cell in the named range 1320. In embodiments, named ranges may be traded by right clicking on the order type cell 1320 and choosing to open a corresponding order ticket from a context menu, where the values of the named range are used to populate the order ticket. In addition, a named-range-based trade may be initiated by choosing to trade the named range from the same context menu, which will immediately submit the order as if it was called by a trading custom function. Lastly, a user may have the ability to double click on the order type cell 1320 to immediately submit an order based on the template and its values. In embodiments, any or all cells in a named range may be right click and/or double click enabled. In embodiments, any of these trading types can be set to place the trade without additional confirmation by the user.

Referring to FIG. 8B, in embodiments, named-range trading parameter templates may have special fields and key-value pairs that support any kind of automation or other suitable operation or purpose. In embodiments, four special fields, Status 1360, CancelFirst 1365, CloseFirst 1370, and IfDone 1375 support automated trading. Any other possible key-value pair linked to actions of any type may be added to a named-range trading parameter template.

In embodiments, Status 1360 has a value field that displays the state of the last order submitted using the named-range trading parameter template in which it is located. In embodiments, the global variable method of the present invention, as more fully described later, is used to display the current real-time value of the named-range trading parameter template's order state in the Status 1360 value field, which in embodiments is a cell in the spreadsheet interface. In embodiments, the Status 1360 value field is populated using an automated order and position state management method of the present invention as more fully described below.

In embodiments, the initial status value displayed is Ready, which means that a call to this named-range trading parameter template with any custom trading function, e.g., TRD( ), would result in submission of a new trade message (also referred to as an order) using the information contained in the named-range trading parameter template. In embodiments, the Status value from a previous run of the application is persisted to a storage medium, as more fully described later, and used to initialize the Status 1360 value field to the prior state upon application startup. Canceling any order or closing any position associated with a named-range trading parameter template will return the Status field value to the Ready state.

The order and position state associated with a named-range trading parameter template is checked before submission of any order from the named-range trading parameter template when called by trading custom functions to prevent duplicate orders and support other desired transactional control. In embodiments, automatic spreadsheet trading for a named-range trading parameter template is allowed only for the following statuses of the named-range trading parameter template: (i) For new order entry: Rejected, Cancelled, Ready, or Error status, and (ii) For cancellation and/or modification of an existing order: Pending status only.

In embodiments, when the trading option to ignore consecutive trades in the same direction is enabled, a named-range trading parameter template with the Status Ready will not result in a trading message, but will display the IgnoringConsecutive status if it would open a position in the same direction as the most recently closed position.

In embodiments, the possible states are: PendingAdd—an order has been sent to the market and a confirmation is being awaited; PendingCancel—a cancel request has been sent to the market and a confirmation is being awaited; PendingModify—a modification request has been sent to market and a confirmation is being awaited; Pending—an order sent to the market has been accepted and is active; Rejected—an order has been rejected by market; Executed—an order has been executed (i.e. filled) by the market; Part Done—an order has been executed (i.e., filled) partially by the market; Part Closed—a position has been closed out partially; Cancelled—an order cancel request has been sent to the market and successfully cancelled; Ready—no pending order or open position is associated with the named-range trading parameter template; Error—an error occurred when attempting to send an order to the market; IgnoringConsecutive—an order was triggered but not sent to the market in order to comply with the enabled trading option to ignore consecutive trades in the same direction; and Inactive—a startup status when a related order is active or position is open in the database, but no related information has been received from market yet (i.e., it cannot be determined if a related order or open position is still active at the market at startup despite attempts to reconcile).

In embodiments, the automated order and position state management methods of the present invention are used to check the status of orders and positions originating from a named-range trading parameter template before submitting another order from the same named-range trading parameter template. In embodiments, this is accomplished by assigning a unique name or identifier to each named-range trading parameter template and automatically receiving and processing trade messages received from the market or other trade execution venue or trade execution system to track the relationship between orders and positions and named-range trading parameter templates both in-memory, and optionally, with a persistent data store that can be accessed after an application restart to restore the in-memory order and position state.

FIG. 8C depicts an alternative user interface that facilitates user creation of a named-range trading parameter template. In the depicted embodiment, the interface can receive a list of named range for each of the fields: CancelFirst 1365, CloseFirst 1370, and IfDone (not shown in FIG. 8C) 1375, among others. In embodiments, CancelFirst 1340 is a field that may contain one or more comma-separated trading parameter template named-range names for which the automated order and position state management code will look up and check the status of, and if any orders from these trading parameter templates are in a Pending state, they will be automatically cancelled before the trade from the present trading parameter template is processed. Similarly, CloseFirst 1370 is a field that may contain one or more comma-separated trading parameter template named-range names for which the automated order and position state management code will look up and check the status of, and if any open positions originating from the listed trading parameter templates exists, they will be automatically closed before the trade from the present trading parameter template is processed. Likewise, IfDone 1375 is a field that may contain one or more comma-separated trading parameter template named-range names which the automated order and position state management code will automatically process orders from when the present trading parameter template status has reached an Executed state.

In embodiments, the order and position state management method is comprised of three primary modules: an in-memory relationship map, a persistent relationship map, and code that processes proposed outgoing trade message and incoming trade message events and checks and updates relationship maps as well as sending update events to other modules that have subscribed to the relationship map changes such as the global variables, as described in greater detail later, that are used to display the Status 1360 value field.

In embodiments, the in-memory relationship map is a hash table with one-to-one relationships of (named-range trading parameter template name, workbook name)-to-(last order id, last trade id). In embodiments, there is one in-memory relationship map hash table for each pair of elements (status, symbol). Each order and position has a reference to a corresponding named-range trading parameter template. The in-memory map subscribes to order and trade message events and each event causes the in-memory map to be updated and further, notifies all modules that have subscribed to the in-memory map update events.

In embodiments, the persistent relationship map may be an SQL database of any kind. The relationship map table may look as follows:

CREATE TABLE templates

(

| | |
|---|---|
| name | CHAR(64) NOT NULL, |

| | |
|---|---|
| workbook | CHAR(64) NOT NULL, |

| | |
|---|---|
| location | CHAR(128) NOT NULL, |
| ordered | CHAR(32), |
| traded | CHAR(32), |
| status | INT, |
| brokerid | INT, |

| | |
|---|---|
| accounted | CHAR(32) |

);

Where: name—is the named-range trading parameter template name; workbook—is the name of the spreadsheet workbook where the named-range trading parameter template is located; location—is the address of the named-range trading parameter template in the workbook; ordered—is the unique order identifier for the last order submitted for the named-range trading parameter template; traded—is the unique trade identifier assigned to the last position opened by the named-range trading parameter template; status—is the status value displayed in the named-range trading parameter template; brokerid—is the unique identifier assigned to the broker that the record is associated with; and accountid—is the unique account number that the record is associated with.

In embodiments, upon receipt of a new change event, the persistent relationship map is updated synchronously using a background thread to ensure that the persistent store matches the current state of the system. This makes it possible to shut the application down and to restart it without losing the order and position state. In a case where the persistent relationship map cannot be reconciled with the orders and positions obtained from the market or other trade execution system at application startup, the Status field for any named-range trading parameter template with a state change will display Inactive to indicate a state change while offline, e.g., such as through the execution of a child order of an open position, as previously described.

In embodiments, the code surrounding the order and position state management method of the present invention is responsible for subscribing to order and trade update events, updating the in-memory relationship map hash table, updating the persistent relationship map SQL table, and sending events to subscribers of order and position state change events.

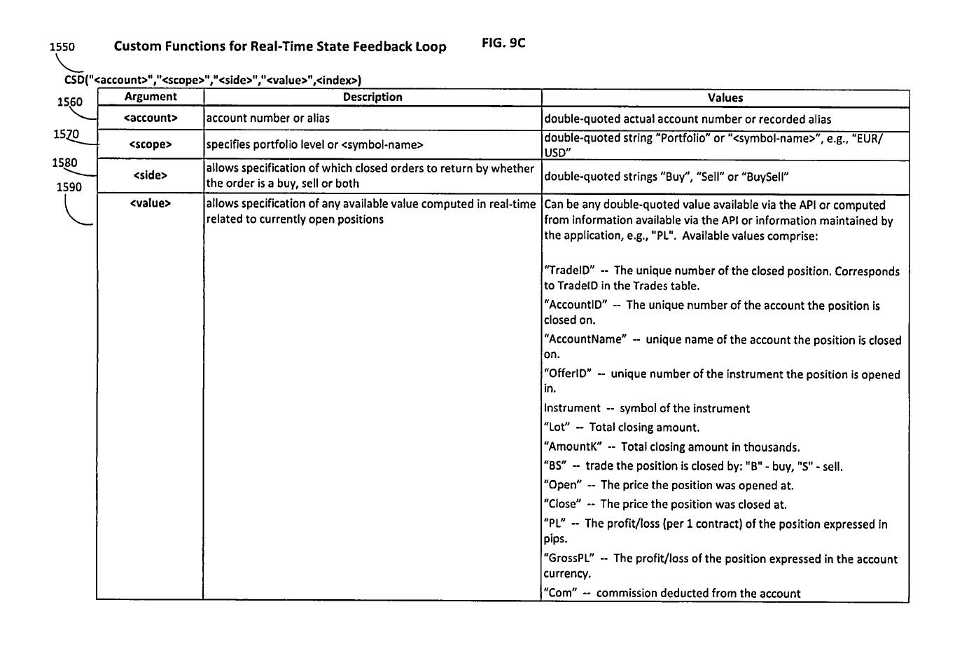

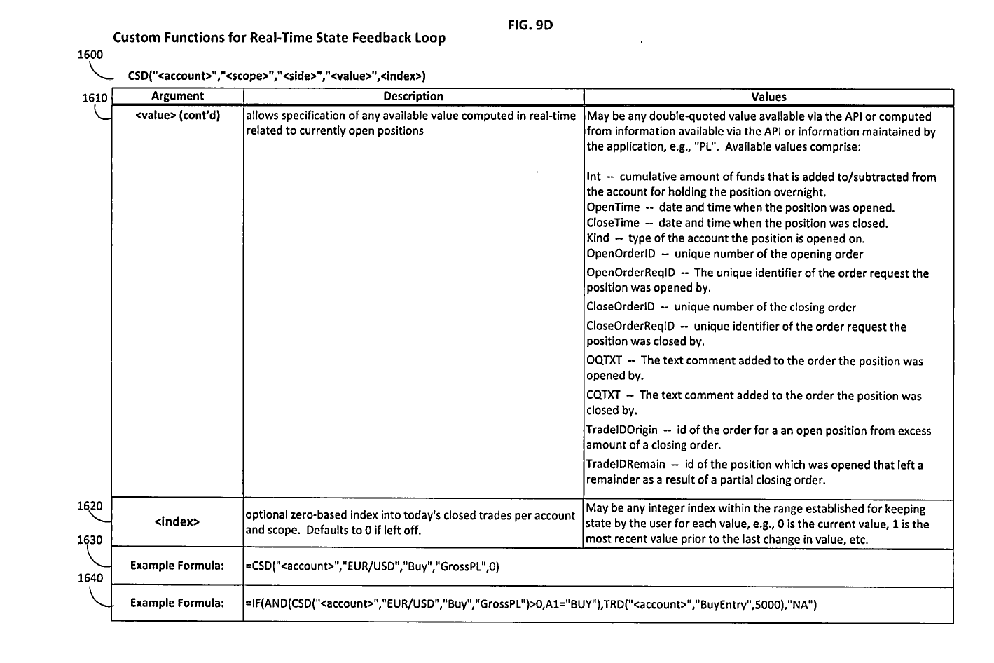

FIGS. 9A, 9B, 9C, and 9D illustrate a table of custom real-time feedback loop functions according to embodiments of the present invention. Referring to FIGS. 9A-D, the table contains three custom functions that are used to perform trading operations. One skilled in the art shall recognize that other functions may be generated and used.

In embodiments, the first custom function, ORD( ) 1400, allows for real-time feedback about order state. Specifically, it may be used to find out what orders currently exist in the market and in what amounts. For orders that are not appropriate to net with respect to computing the total amount of the outstanding orders of that type, or for certain logic that requires knowing about the presence of a particular type of order, a Boolean value may be returned. In such embodiments, 1 may indicate the existence of the specified order type and 0 may indicate that no order of that type is found. In embodiments, it has the following argument signature:

ORD(“<account>”,“<scope>”,“<side>|<order-type>”,“<calc-type>”,“<index>”)
The first argument, <account> 1410, works as it does for other previously described functions, where the user specifies the account number or alias.

In embodiments, the second argument, <scope> 1420, works as it does for other previously described functions, where the user specifies “Portfolio” or the tradable instrument symbol such as “EUR/USD” control the scope of the computation. In embodiments, one difference when used with ORD( ) is that the net amounts returned are converted into a common currency using the account's base currency by default. In other embodiments, an additional argument for use with “Portfolio”<currency> can be used to specify the base currency the amounts should be converted to.

In embodiments, the third argument, <side>|<order-type> 1430, also works as it does for other previously described functions, where the user specifies Buy, Sell, or BuySell to indicate either Buy, Sell, or both for the <side> portion of the argument, and then specifies valid order types that they are interested in checking for with the <order-type> side of the argument. For example, “Buy|EntryLimit” will check for Buy orders that are of the type EntryLimit, and ignore any other orders that do not match. Multiple order types may be specified for one side, for example “Buy|EntryLimit|OCO.” In embodiments, multiple combinations of <side>|<order-type> may be combined by using a semi-colon as a delimiter. Consider the following example: “Buy|EntryLimit; Sell|OCO”.

In embodiments, the fourth argument is <calc-type> 1440, which may be an optional argument that specifies the aggregation method for computing a single return value from all pending orders. “Net”, which is the default if this argument is omitted, computes (Buys+Sells) for the specified order types, returning a net long or short exposure for all pending orders. The user can also specify “And” or “Or.” In embodiments, “And” returns a Boolean value of 1 if each of the <side>|<order-type> combinations exist, else it returns 0. In embodiments, “Or” returns a Boolean value of 1 if either of the specified <side>|<order-type> combination exists, else it returns 0.

To illustrate a utility of ORD( ) one can create an ORD( ) formula in a cell to indicate whether an offsetting OCO order has been successfully placed after a new trade entry, which can be used for visualization and manual monitoring of the trading strategy. Other spreadsheet formula logic may reference a cell containing an ORD( ) function in order to programmatically determine whether to call CAN( ) when a trading signal changes or a position is exited, or perform some other function such as determine whether an order is already in the market in order to control position sizing. An example of ORD( ) used within a spreadsheet formula is shown at 1460 with a nested example at 1470.

In embodiments, ORD( ) 1400 returns Boolean values, where 1 indicates the existence of the specified order types and 0 indicates no orders of that type exist. This abstraction can greatly simplify logic that requires information about order state because it is not necessary to get a list of all orders back and perform the filtering within the logic encapsulated in a spreadsheet formula. In alternative embodiments, ORD( ) or another custom function may return the full list of all pending orders and add them to a named range or other suitable structure in the spreadsheet user interface or an in-memory cache for further processing by the same or other custom functions or spreadsheet logic.

Another unique aspect of the real-time feedback loop is that, in embodiments, the user may set global variables that specify the number of prior values of a time series of changes in order state to maintain in the dynamic cache for any available feedback loop value, which correspond to index values and may be accessed with the optional fifth argument <index> 1450. In embodiments, the broker's trading server or other suitable server stores a history of these values that are used to initialize the historical state in the dynamic cache. In alternative embodiments, these values are initialized from changes in the data values as computed from new data updates and not stored during application shutdown.

Turning now to FIG. 9B, in embodiments, the second custom function, POS( ) 1480, allows for real-time feedback about open position state. It may have the following argument signature:

POS(“<account>”,“<scope>”,“<value>”,“<index>”)

The first argument, <account> 1490, works as it does for other previously described functions, where the user specifies the account number of alias. The second argument, <scope> 1500, works as it does for other previously described functions, where the user specifies “Portfolio” or the tradable instrument symbol, such as “EUR/USD,” to control the scope of the computation. In embodiments, one difference when used with POS( ) is that the net amounts returned are converted into a common currency using the account's base currency by default. In other embodiments, an additional argument for use with “Portfolio”<currency> may be used to specify the base currency to which the amounts should be converted.

In embodiments, the third argument, <value> 1510, is an identifier for values available through APIs or computed from information available through APIs accessible by the system or information maintained by the application or any suitable server or other system component. For example, position size, profit and loss metrics, or any other suitable value might be made accessible. Examples of available values are shown in the values column of 1510. For example:

=POS(“<account>”,“EUR/USD”,“NetPL”, “<index>”)

when entered into a cell in the spreadsheet user interface will return the current NetPL as updated in real time with each spreadsheet engine recalculation.

In embodiments, the user may set parameters that specify the number of indices of a time series of changes in position state to maintain in the dynamic cache for any available feedback loop value and which may be accessed with the optional fifth argument <index> 1520. An example of an ORD( ) function used within a spreadsheet formula is shown at 1530 with a nested example at 1540.

Turning now to FIGS. 9C and 9D, in embodiments, the third custom function, CSD( ) 1550, allows for real-time feedback about closed position state. It may have the following argument signature:

CSD(“<account>”,“<scope>”,“<side>”, “<value>”,“<index>”)

The first argument, <account> 1560, works as it does for other previously described functions, where the user specifies the account number of alias. The second argument, <scope> 1570, works as it does for other previously described functions, where the user specifies “Portfolio” or the tradable instrument symbol such as “EUR/USD” to control the scope of the computation. The third argument, <side> 1580, works as it does for other previously described functions in the two-sided argument <side|order-type>, where the user specifies “Buy,” “Sell,” or “BuySell” for the side, and optionally any order types to return values from records that match.

The fourth argument, <value> 1590, is an identifier for values available through APIs or computed from information available through APIs accessible by the system or information maintained by the application or any suitable server or other system component. For example, profit and loss, open time, close time, or any other suitable value may be accessed. By way of example, the currently available values are shown in the values column of the table at 1510.

In embodiments, the last argument is <index> 1620, which, in embodiments, is an optional argument for specifying a zero-based index value into the current day's list of closed trades. The index may be any integer value supported by the broker's trading server or other API or any form of cache of the prior state. If omitted, the default index of 0 may be used for the current day. An example of CSD( ) used within a spreadsheet formula is shown at 1630 with a nested example at 1640.

In alternative embodiments, an additional argument for specifying an index for the day of the closed positions is also supported, where the history can be stored in a database or other server application for loading into the dynamic cache. One skilled in the art shall recognize that other index schemes may be used.

In embodiments, a module, which may be an embedded or distributed part of the system, tracks all orders and positions, and builds a cache that can be used to supply state to feedback loop custom functions as described herein. In embodiments, this state cache may contain any information about the orders as may be suitable for various types of real-time filtering. One specific example is linking each conditional order and immediate order and the positions that arise from them with the workbooks and/or worksheets they arise from so that the custom feedback loop functions can use an optional filter argument to specify the originating workbook and/or worksheet. In other embodiments, this information in the cache may be obtained either through an optional custom trading function argument for tagging the orders they generate, or by any other suitable means including extra trading message fields within named-range trading templates or externally specified, or any other mechanism.

In embodiments, the feedback loop custom functions have an optional argument, <tag>, for specifying the workbook and/or worksheet of origin or any other tag added by trading custom functions for any order or position so that trading strategy logic can be developed relative to a particular trading strategy. For example, if a user wishes to run two trading strategies both trading EUR/USD, and the strategy logic determines if it should trade based upon whether or not there is already an existing EUR/USD position, each strategy needs to know if the existing position is relative to (originating from) the strategy itself, or if it was generated by the other trading strategy. Alternatively, this argument may support filtering on tags that were added by the optional tag argument in trading custom functions or that were added to trade messages with a tag message field.

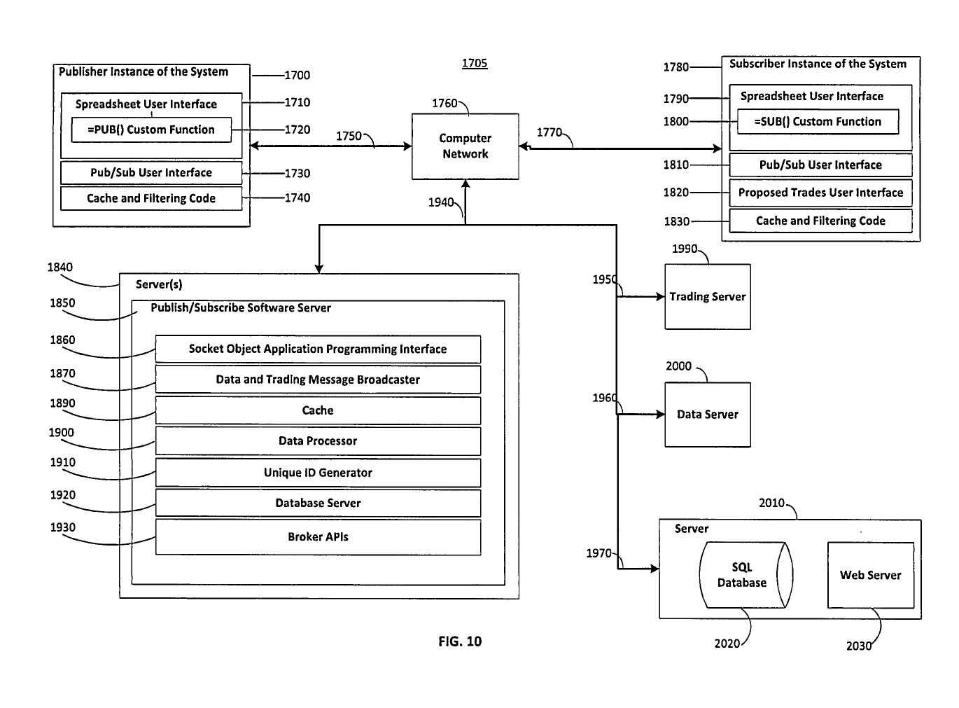

FIG. 10 illustrates publishing and subscribing according to embodiments of the present invention. Referring to FIG. 10, the application (e.g., application 200) with the embedded spreadsheet engine supports publishing and subscribing via custom functions PUB( ) and SUB( ) as more fully described later, and an extensible server-side module that contains services that are desirable.

In embodiments of the present invention, the application with the embedded spreadsheet engine (e.g., application 200) may publish content messages (which shall be understood to comprise data, trading messages, or a combination thereof) directly or indirectly from or to, and/or subscribe to data and trading messages directly or indirectly from, any other instance of the application. In embodiments, this is in addition to and concurrent with the system's ability to get data from a data server and send trade messages to a trading server using one or more of the methods described herein.

For example, in embodiments, a publisher instance of the system 1700, which contains a spreadsheet user interface 1710 that can contain any number of formulas in cells using the custom function PUB( ) 1720 to publish data and/or trading messages to one or more subscriber instances 1780. In embodiments, the subscriber instance of the system 1780 contains a spreadsheet user interface 1790, which can contain any number of cells containing formulas using the custom function SUB( ) 1800 to receive subscriptions to data and/or trading messages and/or alert messages.

An aspect of embodiments of the present invention is a user interface for registering and managing publisher and subscriber data and trading messages 1730 and 1810, which may be part of user interface 210. A primary functionality of this user interface is to provide capabilities for a logged in user.

Examples of functionality available to users includes, but are not limited to, one or more of the following:
1. View the user's existing content services (e.g., published data or systems) and/or subscribed content service (e.g., data or trading systems or messages)
2. View key attributes of each published data or trading system including the name, unique identifier, description, credit or debit details related to the data or trading systems or messages being published or subscribed to, performance, ranking, and/or other information that may be suitable or desirable to display
3. Register to publish data or trades and messaging by registering one or more content services, including:
   a. Adding key information such as the name, description, subscription fees, and terms
   b. Submitting a request to the publish/subscribe server to generate a unique identifier, which is captured by the system and registered to the user, and viewable by other users on the system together with other descriptive information for purposes of subscribing once linked to a published stream
   c. Tools for specifying the cells or ranges of cells in the spreadsheet user interface that contain the PUB( ) and/or SUB( ) formulas related to each unique identifier.
4. Signing (or otherwise registering their assent to) agreements for payment, fee splitting, and other terms
5. Manage any published data or trading systems or messages and any subscriptions to the same including:
   a. Updating the information
   b. Deleting the unique identifier and everything related to it in the system
   c. Turning on/off automatic and semi-automatic trading
   d. Setting trading risk constraints and other settings
   e. Otherwise setting one or more modifying parameters for changing a published trading message for the subscriber (such as, setting limits, leveraging factor(s), specifying types of trades in which to participate, specifying types of trades in which not to participate, setting trading instruments, or any other parameter that affects a trading message). It shall be noted that a modifying parameter may result in not participating in a trade or other action.

In embodiments, the publish/subscribe user interface 1730 and 1810 is part of the application (e.g., application 200); however, in alternative embodiments, it may also be a web-based or other standalone user interface with some or all of the features detailed or additional features.

Another aspect of embodiments of the present invention is the publish/subscribe server 1850 and associated methods. In embodiments, this component contains the application programming interfaces and code that provides other services related to the action of publishing and subscribing to data and trading message streams. In alternative embodiments, one or more of the components may be distributed.

In embodiments, the publish/subscribe server contains a socket-object-based API 1860 for handling communications between itself and the publisher and subscriber instances of the system.

In embodiments, the data and trading message broadcaster component 1870 of the pub/sub server 1850 contains the event handlers for messages produced by the PUB( ) and SUB( ) custom functions, as more fully described later. It also may contain an in-memory list of the registered listeners, which is updated when events are received when a client using a SUB( ) custom function is registered. In embodiments, each published stream of data, trading messages, and alert messages are multicast if there are at least one registered listener for the particular stream. It shall be noted that any data broadcasting scheme may be used in place of multicasting.

In embodiments, publishing and subscriptions can be for data, trading messages, or alerts. The cache 1740 may be used to store the cell coordinates map and previous event values to support message filtering to increase efficiency, as more fully described later. In embodiments, after each spreadsheet recalculation (which itself may be triggered by incoming events, changes to contents, or changes to formulas in cells or any other suitable event), any changed values of cells referenced within PUB( ) are sent with their cell coordinates and new values as events to the pub/sub server 1850.

In embodiments, single cell references can be published by specifying the cell coordinate in the PUB( ) function as more fully described later. Multiple cell references, both adjacent and distributed may also be published. For example, A1, B2, and D3 can be published together under a single unique identifier. One-dimensional cell arrays such as C1:C10 and two-dimensional arrays such as C1:D5 may also be published. It shall be noted that references to one-dimensional and two-dimensional arrays in this patent document are by way of example and not limitation; accordingly, arrays may be of arbitrary dimension or size. It shall be noted that any combination of the above may be published under a single unique identifier as more fully described later.

In embodiments, the X and Y coordinates of each cell being published map to actual cell coordinates for the publisher, but are mapped to relative cell coordinates for the subscriber. A modified Cartesian graph is used that matches the way a typical spreadsheet is designed. It is similar to the fourth quadrant of a Cartesian graph because the origin is in the upper leftmost corner and the axes extends downward and towards the right, however, like a spreadsheet, no negative numbers are used for the Y-axis coordinates as would be used in a typical Cartesian graph. Further, the coordinates of the origin are not 0 based, as they would be in a typical Cartesian graph's fourth quadrant. Rather, as in a typical spreadsheet, cell A1 is the first cell at the origin. The origin of the graph that is mapped to A1 then is (x1,y1) and follows from there, as shown below:

| | A | B |
|---|---|---|
| 1 | (x1, y1) | (x2, y1) |
| 2 | (x1, y2) | (x2, y2) |

In embodiments, the subscriber placement of the cell containing the SUB( ) function indicates the origin for the relative cell mapping. For example, a publisher may publish the two-dimensional array A1:B2 as shown above in the publisher's workbook. The subscriber might put the SUB( ) function for the data published in A1:B2 in cell B3, which establishes B3 as the origin for the graph. In embodiments, the publisher's data in A1:B2 is mapped to relative cell coordinates in the subscriber's workbook starting in B3. The data updates are then in cells that take the same structure as the publisher intended, but without a dependency on where the subscriber may place the SUB( ) custom function in their workbook. The example described above is shown below.

PUBLISHER

| | A | B |
|---|---|---|
| 1 | (x1, y1) | (x2, y1) |
| 2 | (x1, y2) | (x2, y2) |

SUBSCRIBER

| | | |
|---|---|---|
| A | B | C |

| | | |
|---|---|---|
| 1 | | |
| 2 | | |
| 3 | (x1, y1) | (x2, y1) |
| 4 | (x1, y2) | (x2, y2) |

As shown in the example above, B3 becomes the subscriber's origin with (x1,y1) coordinates. Using this method, the system may update the subscriber's B3 with the publisher's data from A1, B4 with A2, C1 with B1 and C2 with B2.

In embodiments, both the publisher and subscriber instances of the application (e.g., application 200) with the embedded spreadsheet engine and spreadsheet user interface and the pub/sub server have in memory caches, 1740, 1830 and 1890 respectively, for storing the data, including coordinates map being published or subscribed to, and the latest value of the data or trading message being published. In alternative embodiments, any other suitable values may be stored in the pub/sub cache 1890. In embodiments, the pub/sub cache methodology may use a unique identifier and the relative cell (x,y) coordinates as a unique key into the cache for the single cells, collections of single cells, as well as single and two-dimensional arrays, or any combination of these structures. By way of illustration, the key for a two-by-two matrix would be:

21EC2020-3AEA-1069-A2DD-08002B30309D|x1,y1|x2,y1|x1,y2|x2,y2
where 21EC2020-3AEA-1069-A2DD-08002B30309D is a unique identifier and |x1,y1|x2,y1|x1,y2|x2,y2 represents the relative cell coordinates.

In embodiments, the PUB( ) custom function sends a message when called upon for each recalculation of the spreadsheet when at least one of the new values differs from the previous values as stored in the cache and compared using filtering code 1740. In embodiments, optional controls may be implemented to reduce the messaging rate by imposing limits on the calling or effective calling of the function. For example, in embodiments, a timer may be set to limit the number of times the function may be called or the result message sent. Alternatively or additionally, the filtering code may be used to compare the new values returned after a spreadsheet recalculation that are to be published with the last value previously published so that repeat values are not published in order to increase efficiency and scalability. One skilled in the art shall recognize that a number of filtering schemes may be used to manage outgoing messages. In embodiments, the message contains key-value pairs containing the unique identifier and the cell coordinate that has a changed value along with the new value that is being sent to the pub/sub server 1850 for broadcasting. For purposes of illustration, a plain text example of the message is shown below:

ID=21EC2020-3AEA-1069-A2DD-08002B30309D|x1,y1|x2,y1|x1,y2|x2,y2
x1,y2=1.49738
x2,y2=0.90875

In the above message, two specific cells' values related to a single unique identifier have changed and are being sent to update the subscriber's spreadsheet, out of any number of other cells whose values have not changed since the last time the PUB( ) custom function was called in the publisher's spreadsheet. In alternative embodiments, the message format may be any suitable representation or format including, for example, binary and/or compressed messages.

In embodiments, trading messages are not stored in the pub/sub server cache 1890. Unlike data messages (or the data portion of a mixed-type publishing) where only the changed values are actually part of the message, in embodiments, all trading messages are sent to the pub/sub server and broadcasted to subscribers or directly to the broker API 1930 after being enriched with subscriber account coordinates. In embodiments, the subscribers may set parameters controlling the trade size and other parameters related to the trading in their accounts as a result of subscribing to one or more publisher trading message streams. The published trading messages may be sent in the aggregate, in one or more trading messages, for all subscriber accounts directly to one or more broker APIs 1930 and/or trading servers 1990 for execution as one or more block orders, as is familiar to those skilled in the art. Post trade execution, the block order may then be allocated automatically to all subscriber accounts, whereby all subscribers see their respective trade allocation in their brokerage accounts and/or in their instance of the application, and whereby all subscribers receive the same order execution price on a pro rata basis, or as otherwise specified by the parameters set by the subscribers with respect to the aggregated block order, such as those that increase or decrease the standard leverage or otherwise alter the pro rata calculation, including but not limited to skipping trades altogether or due to margin levels and/or other risk controls applied by the subscriber voluntarily or by the system generally. The advantage of executing the trades as an aggregated block order and allocating the subscriber positions post trade execution is that it enables all subscribers to get the same execution price in addition to allowing trade execution to be more efficient in various ways, including through the use of specialized execution algorithms and/or one or more execution venues including specialized execution venues for large orders, as are familiar to those skilled in the art. In embodiments, an optional throttling control may impose a limit on the number or frequency of trading messages sent. In embodiments, if no model account number is specified and no listeners are registered, no message is sent.

In embodiments, when trading messages are published, the messages are routed by the data and trading message broadcaster 1870 in the pub/sub server 1850. In embodiments, messages are routed either directly to the subscriber's instance of the application (e.g., application 200) containing the SUB( ) custom function with the unique identifier of the published trading messages, and/or to the broker API 1930. Whether or not messages are routed to both recipients may be dependent upon whether the publisher has defined the <model-account-number> argument in the PUB( ) custom function and/or how the subscriber has defined the <mode> argument in the SUB( ) function, as described more fully later.

Consider, by way of example and not limitation, the following trading message broadcasting embodiments:

1. If a custom function PUB( ) referencing any cells containing any trading custom functions is specified with a valid argument for <model-account-number>, and the publisher's instance of the application (e.g., application 200 or 1700) with the embedded spreadsheet engine is logged into the broker's servers, the trading messages will be sent by the data and trading message broadcaster 1870 to the broker API 1930 for the account number specified in <model-account-number>. In embodiments, whether or not <model-account-number> is specified, the trading messages related to each PUB( ) custom function's unique identifier will be available to subscribers.

2. If a SUB( ) custom function is referencing the unique identifier of the PUB( ) custom function as described above, and if the <mode> argument is set to “Semi,” the data and trading message broadcaster 1870 will publish trade message events to the subscriber instance of the application (e.g., application 200 or 1780) with the embedded spreadsheet engine which will be displayed in a “Proposed Trades” panel of the user interface. This interface allows the user to review and accept or reject each trading action represented by each trading message. When these trades are approved, they may be routed to the broker trading API.

3. If a SUB( ) custom function is referencing the unique identifier of the PUB( ) custom function as described above, and if the <mode> argument is set to “Auto,” the data and trading message broadcaster 1870 will enrich the messages with the relevant subscriber account coordinates and publish trading message events directly to the broker API for the subscriber's specified accounts, where the trades represented by the trading messages will automatically be executed in the subscriber's specified accounts.

In embodiments, if data is subscribed for, the cell that contains the SUB( ) formula will be the cell that gets updated. If the data is a collection of cells, a one-dimensional array, a two-dimensional array, or any array of arbitrary dimension and size, or a combination thereof, the initial cell containing the SUB( ) formula may be the starting point (or origin with x1:y1 coordinates) of the collection of cells and/or arrays and the origin cell and other relative cell coordinates will be filled with data. In alternative embodiments, the initial SUB( ) formula is placed into a cell that becomes the origin, and a SUB( ) formula with each unique relative cell coordinate is automatically propagated to each relative cell in the published collection of cells, where the SUB( ) formula in those cells is a unique key and maps into the cache for individual cell coordinates.

In embodiments, if trading messages are subscribed for, the cells that contains the SUB( ) formula may display a descriptive label or other message, e.g., “TRD Semi” or “TRD Auto,” wherever a trading custom function is positioned. Any other suitable message may be displayed to indicate that the cell is occupied by a formula. In the subscriber's instance of the application (e.g., application 200 or 1780), order state, open, and closed position state custom function cells that are subscribed for, may contain and display the actual data updates that would be visible in the publisher's instance of the application (e.g., application 200 or 1700).

In embodiments, if “Mixed” is subscribed for, the cells that contain the SUB( ) formula that references cells calling trading custom functions, as opposed to publishing data, may display a descriptive label or other message, e.g., “TRD Semi” or “TRD Auto,” depending upon the SUB( ) <mode> argument. The cells that contain the SUB( ) formula that references data being published will display the current value of the published data. In the subscriber's instance of the application (e.g., application 200 or 1780), order state, open, and closed position state custom function cells that are subscribed for, may contain and display the actual data updates that would be visible in the publisher's instance of the application (e.g., application 200 or 1700).

In embodiments, events from custom functions PUB( ) and SUB( ) are sent as plain text to maximize human readability, but alternative embodiments may use binary or other representations of the messages.

In embodiments, all events originating from the custom function PUB( ) are accessed with a system generated and registered unique identifier, and may therefore be subscribed to with the custom function SUB( ) in any instance of the application with the embedded spreadsheet engine and spreadsheet user interface.

In alternative embodiments, a chart or other embedded object in the spreadsheet may also be included for publishing by clicking on the object when selecting cells for the PUB( ) custom function. The object identifier is added into the formula and all of its data dependencies, parameters, and settings are transmitted as part of the published stream and automatically created for the subscriber in their workbook when processed by the SUB( ) custom function. In embodiments, any workspace element or the entire workspace may be published including all GUI components, settings and layouts. Any suitable representation of the data required to replicate the objects may be included in the published stream.

In alternative embodiments, other applications, such as mobile phone applications, could register for events and or published streams using an API that makes the custom function SUB( ) available to the application. Likewise, an API may make the custom function PUB( ) available so that other applications could publish events and/or published streams for use with the SUB( ) custom function in a subscriber instance of the application with the embedded spreadsheet engine and user interface 1780, or any other application or user interface.

In embodiments, the unique identifier generator component 1910 of the pub/sub server 1850 accepts incoming requests from a client for a unique identifier to be generated and produces a GUID, which is a string that is guaranteed to be unique. Any other form of unique identifier may alternatively be used. In embodiments, the GUID is registered to the user originating the generation request and stored in the user's information in the database 2020 along with other information about the published stream. An event is sent to the client of the user making the request for the unique identifier so that the unique identifier and associated information may be displayed to the user in the pub/sub user interface in the application with the embedded spreadsheet engine, as well as to the clients of all potential subscribers.

In embodiments, the data processor component 1900 accesses data from other parts of the system or any third-party external system and with or without further processing and makes it available to other consumers within the system. For example, data processor component 1900 may connect to one or more databases through the database server 1920, obtain login usernames and passwords for all publisher streams linked to a model account, and connect to the broker's data server through the broker API 1930 and obtains information, such as closed trades for each account. In embodiments, the collected data is used to compute various metrics, including (by way of example) the current profit and loss, percentage of winning trades, average win/loss per trade, etc. In embodiments, some of the raw data collected is stored in the database for use in future processing. For example, the current largest losing trade and largest winning trade may be stored in the database and checked against the largest loser and winner in the closed trades list at the conclusion of each day, with the replacement values stored if there is a new largest losing and/or winning trade. In embodiments, other information may be used to rank the publisher streams by profit/loss or other metrics, with the values stored in the database for retrieval on demand by the web server 2030 when a user of the website that presents the information to end users requests it or when the application with the embedded spreadsheet engine is loaded where the user has systems it follows or is subscribed to that will be displayed in the pub/sub user interface 1710, 1810. In embodiments, the highs, lows, and rankings may be for one publisher, for all publishers, or for some subset of publishers, including only the publishers that a subscriber subscribes to. One skilled in the art shall recognize that any other data may be accessed and processed and displayed in any form of user interface or webpage.

In embodiments, the frequency of the data access, processing, and updating can be daily, or more frequently on a periodic basis or at specific times, such as at the conclusion of each month. The data processor 1900 may also collect real-time information, such as current floating profit and loss, and make this information available to other parts of the system by either publishing it as an event that can be registered for, or through an in-memory object that can be queried on demand or any other storage medium, as may be suitable for a particular purpose.

In embodiments, the data processor 1900 may embody any logic related to data access and processing as well as libraries of methods for the processing, timers for performing periodic or batch jobs, and any other suitable logic or functions. In embodiments, connections to the broker's servers and the database are made indirectly through the database server 1920 and the broker API 1930; however, one skilled in the art shall recognize that any suitable route to the data access may be used in alternative embodiments.

In embodiments, the database server component 1920 is an optional component. In embodiments, it 1920 serves as an interface to the database for the rest of the pub/sub server system 1850. In embodiments, it is responsible for making the connection to any system databases and handling all interactions with the database for both queries and persistence.

In embodiments, one or more communications network 1760 and one or more real-time communication links 1750 and 1770 exists between the publisher instance of the system 1700 and the subscriber instance of the system 1780. Other communications links to other components of the system are more fully described later.

In embodiments, using one or more communications networks 1760, communications links 1750, 1770, 1940, 1950, 1960, and 1970 connect to one or more servers containing the publish/subscribe server 1850, as well as any number of other servers such as a trading server 1990, data server 2000, database 2020, and web server 2030. Communication network 1760 may be any suitable communications network including the Internet, an intranet, a wide-area-network (WAN), a local-area-network (LAN), a wireless network, a digital subscriber line (DSL) network, a frame relay network, an asynchronous transfer mode (ATM) network, a virtual private network (VPN), or any combination of any of the same. Communications links 1750, 1770, 1940, 1950, 1960, and 1970 may be any communications links suitable for communicating data between workstations or other servers containing the instance of the systems 1700 and 1780, and the workstations or servers providing the publish/subscribe functionality of the present invention 1840 and servers 1990, 2000, and 2010, such as network links, dial-up links, wireless links, hard-wired links, etc. In the depicted embodiment, server 2020 and 2030 may be physically on the same machine; however, one skilled in the art shall recognize that they may be on different machine or distributed.

Servers 1840, 1990, 2000, and 2010 may each, or together, be one or more of any suitable server, computer, processor, or data processing device or combination of the same. The applications 1700, 1780, and 1850 and all of the servers 1840, 1990, 2000, 2020, and 2030 may run on one or any number of such suitable servers. Furthermore, the workstations or servers containing the applications 1700, 1780, and 1850 and the server 1840, 1990, 2000, or 2010 or any server representing any or all of them may also contain the application with the embedded spreadsheet engine (e.g., 200, 1700, and 1780) or any other applications and merely transmit a Graphical User Interface or other display screens to the user at a user workstation display (not depicted in this figure for simplicity).

In embodiments, the custom functions PUB( ) 1720 and SUB( ) 1800 and/or the publish subscribe server module 1850 may be used in conjunction with any spreadsheet engine and any type of user interface, such as Excel, or Excel combined with add-ins that provide non-spreadsheet user interfaces for setup and usage of the publish/subscribe features of the present invention.

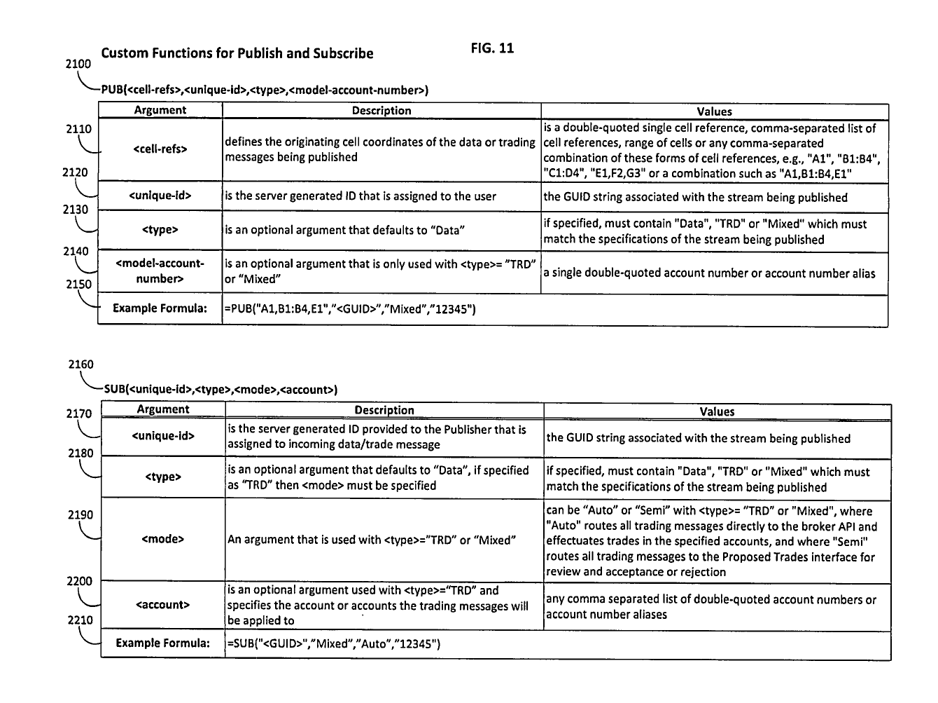

FIG. 11 illustrates a table of custom functions for publishing and subscribing according to embodiments of the present invention. Referring to FIG. 11, the table contains two custom functions, PUB( ) 2100 for publishing data, trading messages, and alert messages, and SUB( ) 2160 for subscribing to data, trading messages, and alert messages.

In embodiments, the first custom function PUB( ) 2100 has four arguments. The first argument, <cell-refs> 2110, defines the originating cell coordinates of the formulas and/or data that comprise or give rise to the data, trading messages, or alert messages that are being published. In embodiments, the values may be any double quoted, comma-separated cell references. For example:

### Single Cell: “A1”

### Discontinuous Cells: “A1,B5,F9”

### One Dimensional Array: “B1:B10”

### Two Dimensional Array: “C1:D5”

### Combination: “A1,B5,F9,B1:B10,C1:D5”

In embodiments, these coordinates are absolute references to cell coordinates in the actual spreadsheet user interface of the publisher instance of the system. In alternative embodiments, they may be other types of coordinates, including coordinates related to a source of data, trading messages, other information not related to an instance of the system, or any other suitable representation for spreadsheet cell coordinates, or any coordinate representation that is mapped into cell references.

In embodiments, the second argument, <unique-id> 2120, is the pub/sub server generated unique identifier assigned to the user for publishing data or trading message streams. Subscribers use this unique identifier for specifying each subscription stream as more fully described later. Generally the identifier is a GUID, although any other suitable unique identifier system could be used.

In embodiments, the third argument, <type> 2130, is an optional argument for specifying the type of publishing stream. In embodiments, the values may be one of three double-quoted strings, “Data,” “TRD,” or “Mixed.” If not specified, the argument may default to “Data.” The value of this argument is used to determine whether it is necessary to obtain trading account coordinates of the subscriber at the time a SUB( ) function listener is registered. In an alternative embodiment, “Alert” is another publishing stream, which uses the ALERT( ) function as described in detail later. The ALERT( ) message stream is sent to the subscriber's unique alert message reader/display, which has settings for subscribed alerts.

In embodiments, the fourth argument is <model-account-number> 2140, which is an optional argument that is used to specify the trading account number where the trading messages of the publisher are being executed. This account can be a demonstration or real money live trading account. Trading in this account and then executing the same trades in a subscriber account is called mirror or shadow trading, as familiar to those skilled in the art. Trading in an account allows for validation of the publisher's trading strategy and also facilitates reporting and automatically computing performance metrics related to the publisher's trading signals as described earlier. In embodiments, the value for this argument is a single double-quoted account number or alias. An example of a PUB( ) formula is shown at 2150. The PUB( ) formula may be in any cell within the publisher's workbook, and need not be adjacent to the cells being published.

In embodiments, the second custom function SUB( ) 2160 has four arguments. The first argument, <unique-id> 2120, is the pub/sub server generated unique identifier assigned to the publisher for particular data or trading message streams. The user can obtain the unique identifiers in the pub/sub user interface as previously described. Other methods of supplying users with unique identifiers, such as a pre-existing list assigned to each user, or any other method, may be used.

In embodiments, the second argument, <type> 2130, is an optional argument for specifying the type of stream being subscribed to. The values may be one of three double-quoted strings, “Data,” “TRD,” or “Mixed.” If not specified, the argument may default to “Data.” In embodiments, if the <type> argument is specified as “TRD” or “Mixed,” the third argument, <mode> 2190, is also specified. In embodiments, a fourth value may be “Alert” for specifying subscription to alert messages. In other embodiments, Alerts can be handled like data.

In embodiments, the third argument, <mode> 2190, is used when the <type> is “TRD” or “Mixed” to specify whether trading is fully automated or semi-automated with respect to execution in the subscriber account. In embodiments, the values can be “Auto” or “Semi,” where “Auto” routes all trading messages directly to the broker API 1930, and where “Semi” routes all trading messages to the proposed trades user interface 1820 within the subscriber instance of the system 1780 for review and acceptance or rejection.

In embodiments, the fourth argument, <account> 2200, is an optional argument used when the <type> is “TRD” or “Mixed,” which specifies the account or accounts that the subscriber wants the trading messages directed to both for automated and semi-automated trading. In embodiments, the values can be any double-quoted list of comma-separated account numbers or aliases. These account coordinates may be persisted to the database when listeners are registered so that trading messages can be enriched with the subscriber's account coordinates by the pub/sub server as previously described. An example of a SUB( ) formula is shown at 2210. The SUB( ) formula can be in any cell within the subscriber's workbook, which cell will become the origin with respect to the relative cell coordinates of any other cells being subscribed for as previously described.

In embodiments, the system allows subscribers to set controls over the trading activity from each subscription individually, in addition to their own trading activity or all trading activity in the aggregate, such as the maximum trade size, maximum position size, capital-loss or margin-limit-based cease trading, etc.

Turning now to additional functions, embodiments of the present invention may support one or more indicator functions, which indicator functions are well known to those skilled in the art. In embodiments, there are two methods for specifying the parameters of any indicator custom function. First, any indicator custom function may be parameterized by a set of key-value pairs. A default set of custom indicator function argument templates may be stored by the system for initial use and re-setting the defaults.

The key-value pairs may be stored in any format, such as an XML or text file, and can be viewable and editable with a user interface or other suitable method of presentation and access, or the values may be edited directly by opening the file and saving the revisions. For example, the following XML representing key-value pairs:

<?xml version=″1.0″ encoding=″UTF-8″?>
<indicator custom functions>

<indicator id=”Range”>

<input_1>

<data_spec>

<symbol>EUR/USD</symbol

<property>Mid</property>
<attribute>High</attribute>
<interval_multiplier>30</interval_multiplier>

<interval_type>Sec</interval_type>

<window_length>100</window_length>

<index>0</index>

</data_spec>

</input_1>
<input_2>

<data_spec>

<symbol>EUR/USD</symbol

<property>Mid</property>
<attribute>Low</attribute>
<interval_multiplier>30</interval_multiplier>

<interval_type>Sec</interval_type>

<window_length>100</window_length>

<index>0</index>

</data_spec>

</input_2>

<date_time>FALSE</date_time>

<definition>High minus the Low</definition>

<code>[code snippet that calculates the indicator]</code>

</indicator>

Another example is the following key-value pairs as plain text for the same indicator:

### Range

Data-Input-1
Symbol=EUR/USD
Property=Mid
Attribute=High
Interval-Multiplier=30
Interval-Type=Sec
Window-Length=100
Index=0

Data-Input-2
Symbol=EUR/USD
Property=Mid
Attribute=Low
Interval-Multiplier=30
Interval-Type=Sec
Window-Length=100
Index=0
DateTime=FALSE
Definition=High minus the Low
Code=[code that calculates the indicator]

Alternatively, the full set of parameters, or union of parameters that each data input has in common, may be specified within the custom function itself as used in the spreadsheet. For example:

Range(Data-Input-1|symbol,EUR/USD,property,Mid,attribute,High,interval-multiplier, 30,interval-type,Sec,window-length,100,index,0; Data-Input-2|attribute,Low; date-time,FALSE)

### Or:

Range(Data-Input-1|symbol,EUR/USD,property,Mid,attribute,High,interval-multiplier, 30,interval-type,Sec,window-length,100,index,0; Data-Input-2|symbol,EUR/USD,property,Mid,attribute,Low,interval-multiplier,30,interval-type,Sec,window-length,100,index,0; date-time,FALSE)

The first example shows the union of the arguments for Data-Input-1 and Data-Input-2 where only the attribute-<value> key-value pair of Data-Input-2 is called out because it differs from the attribute-<value> of Data-Input-1 while all other key-value pairs are the same. The second example shows every key-value pair listed explicitly.

In embodiments, any argument may be left out or included. In embodiments, if left out, default values in the custom function argument template may be used. In embodiments, if any argument is included, it will override the argument in the template. When the custom function has more than one input, any formula level key-value pair may override all input data templates for the indicator custom functions. Furthermore, any key-value pair may be shared across different inputs to a custom function or group of custom functions, such as a group appearing within a particular spreadsheet workbook. An input data group of key-value pairs may be shared across many indicator custom functions if uniquely named and placed into a common namespace. In such embodiments, only the name or identifier of the input data would appear in a particular indicator custom function.

In embodiments, an optional Definition=<value> key-value pair may contain an alphanumeric string that comprises descriptive information that the system can display in various ways. In embodiments, the optional code=<value> key-value pair may be an actual code snippet and/or reference any other code, including built-in functions or methods that access the data in the dynamic cache that the template key-value pairs are a map into. In addition, an embedded or distributed compiler or interpreter allows users to add custom indicators and code on the fly, which may be automatically compiled and loaded as a DLL at runtime and executed, or interpreted and executed at run time.

In embodiments, like the custom function SYM( ) as previously described, the indicator custom function arguments are keys into the dynamic cache. The data specification related key-value pairs as shown in the above examples may be used to dynamically create, extend, or map into a shared cache of the same data. Result series, whether an intermediate series computed to produce additional input series to the indicator custom function, or the final output series of an indicator custom function, may have their own dynamic cache which the function name and other parameters together are a map into. In embodiments, the key-value pair DateTime=<value> is an optional argument that specifies that the corresponding Date-Time for the function at the specified index will be returned. In embodiments, as with SYM( ), each custom indicator function automatically has a corresponding Date-Time series that can optionally be returned. If the key-value DateTime=<value> is omitted, it may be set to have a default of FALSE.

In embodiments, indicator custom functions automatically compute the initialization requirements of the window length parameter plus the necessary or desired number of buffer values for initialization. In embodiments, new dynamic caches may be created with the initialization and buffer, and existing caches may be extended to include the initialization plus the buffer when the window length is increased.

In embodiments, an initial default copy of each indicator template is used to support right clicks on a cell containing a custom function to restore default parameter settings. In embodiments, each workbook may own its own copy of the indicator custom function definitions and code reflecting any changes from the default, and/or changes from workbook to workbook so that variations may be used concurrently. In embodiments, indicator custom function parameter templates may be viewed and edited directly in the XML or other file, or using a GUI or other editor. In embodiments, arguments may be overridden at the formula level as previously described.

In embodiments, any cell containing one or more functions when right clicked will display a list of the functions in the cell, which can be selected to bring up the argument structure or parameter template, depending upon the type of function. For example, the custom function SYM( ) and standard built-in functions will bring up the argument structure, which will show permissible argument values and/or examples. In embodiments, indicator custom functions display the argument and parameter template and the default values. The values may be edited or the defaults restored. Any other information or tools for specifying or debugging functions may also be accessed this way in embodiments.

In embodiments, the system includes a formula builder tool that leverages indicator custom function parameter templates, making it easy to modify the defaults. In embodiments, a Change Data Spec tool allows users to easily make symbol data changes scoped to a selected range, worksheet or workbook level, as well as choosing whether to apply the changes to SYM( ) custom functions and/or indicator custom functions, and/or symbol name strings appearing in a cell. In embodiments, fine-grained control over changing one specific data specification to another is also supported, and can be applied in the same ways to indicator custom functions.

In embodiments, indicator custom functions may be nested within calls to other standard spreadsheet functions and custom functions. An optional key-value pair “range,<index-range>” may be supported for accessing more than one indicator custom function index value in the dynamic cache. A single index value may also be specified for <index-range>. In embodiments, if the “range, <index-range>” is omitted, the default value may set to be the 0^{th} index. A hyphenated index range or comma delimited combination of indices and/or hyphenated ranges of indices may also be specified where a discontinuous series of data is the desired input.

For example, the standard spreadsheet function, Average( ) may be called on an indicator custom function like relative strength index RSI( ), such as =Average(RSI(range,<index-range>)). Indicator custom functions may be called on each other using the same syntax, for example =EMA(MACD(range,<index-range>)), where EMA represents an exponential moving average function and MACD represents a moving average convergence divergence function. Indicator custom functions may be called on standard custom functions, which take standard arguments, such as cell ranges, for example, =EMA(Average(A1:A10)).

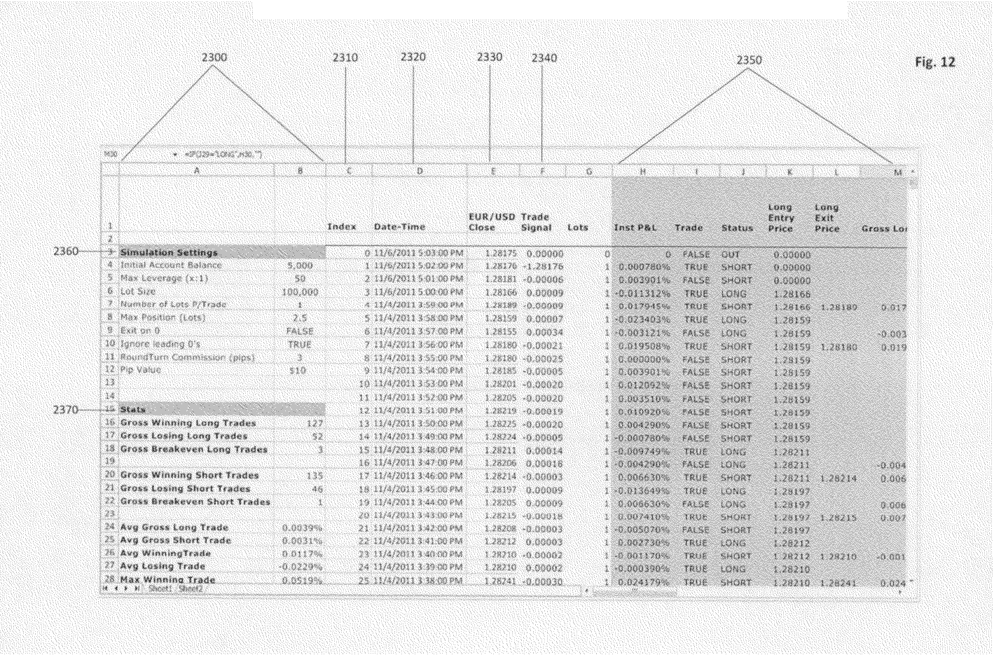

FIG. 12 illustrates a backtest template for backtesting systems and methods according to embodiments of the present invention. Referring to FIG. 12, the first of three methods of trading strategy simulation, or backtesting as it is commonly known to those skilled in the art, is a backtest-template-based method, where a template spreadsheet workbook containing logic to compute and present the results of a full trading simulation, including statistical analysis of the trading results and reports, graphs, and charts, and are pre-built in the spreadsheet and driven by, or linked to, cell references that contain or will contain input data and the trading signal data or formula that computes the trading signal data.

In embodiments, an Add Data dialog (as described in detail later) has an additional set of backtest controls for designating a historical data query as a template backtest query type. When this setting is enabled, the system looks up the default, or user-specified backtest template spreadsheet workbook file. If it is not already opened, the file is automatically opened. If the backtest template spreadsheet file is not specified, a dialog for file selection is displayed, and the user is prompted to specify a template file to open.

In embodiments, the first two columns of the backtest template's first worksheet are reserved for simulation parameter labels and values as shown at 2300, and the third column at 2310 has a header label “Index” and the next non-data column at 2340 contains the header “Trade Signal.” The addition of historical data with the backtest query type enabled, automatically adds the selected data into columns that are inserted between the columns with the Index and the Trade Signal headers, where the headers are used as markers. For example, in embodiments, the optional date-time series is shown as having been inserted at 2320, and the symbol data is shown as having been inserted at 2330. In embodiments, extra columns from previous backtests with different data requirements are automatically deleted. In other embodiments, the backtest historical data may be added to user-specified columns and rows, such as from E3:J3. Other headers or configurations may also be used.

When data is inserted into the template automatically, the formulas in all of the prebuilt logic in the columns following the data may optionally be propagated to match the length of the data so that the simulation will be complete upon data insertion. Alternatively, the backtest setting in the Add Data dialog may be left unselected and the user may insert the data using manually initiated historical data query operations and may propagate formulas to match the length of the historical data manually using standard spreadsheet formula propagation tools.

In embodiments, a Change Data Spec control or feature may be used to change the symbols and all other characteristics of the data including the frequency, properties and attributes. In embodiments, a Change Data Spec control may be a GUI control that allows a user to change any aspect of the data by providing an interface to receive input and makes the changes to the underlying SYM( ) function parameters in each cell and re-acquiring of data, as needed. In embodiments, the Change Data Spec control may be used to change static data in cells, strings, trading parameter templates or any other data contained within or written and/or read into the spreadsheet user interface. For example, to run the backtest simulation on a different symbol, the user may use the Change Data Spec with scope set to workbook and switch from the current symbol to the new symbol, and upon completion of the query and automatic replacement of the data in the backtest template, the simulation will be complete for the new symbol. Any other data parameter may be changed as well, including frequency, etc.

In embodiments, the backtest template logic may be designed to handle initialization issues related to propagating the formula downward in the column by propagating the formula from the appropriate row, and a setting allows the row number from which propagation should begin to be specified. In embodiments, users may customize the backtest template logic, add or modify statistics, reports, charts, graphs, and other simulation features as may be desired with full transparency into all calculations. For example, any of the parameters 2360 that are reference by a prebuilt logic 2350 may be modified by the user. In addition, any of the formulas or other aspects of the pre-built simulation logic 2350 may be modified by the user and any desired simulation logic may be added or deleted. Further, any of the formulas that compute the statistics 2370 may be modified and any desired statistics may be added or deleted. Visualizations in the form of charts, graphs, tables, or conditional formatting of cells, which are not shown in the drawings, may be modified, added, or deleted as desired. In embodiments, users can utilize the data insertion and formula extension automation in whole or in part, or may add data with ordinary Add Data dialog operations.

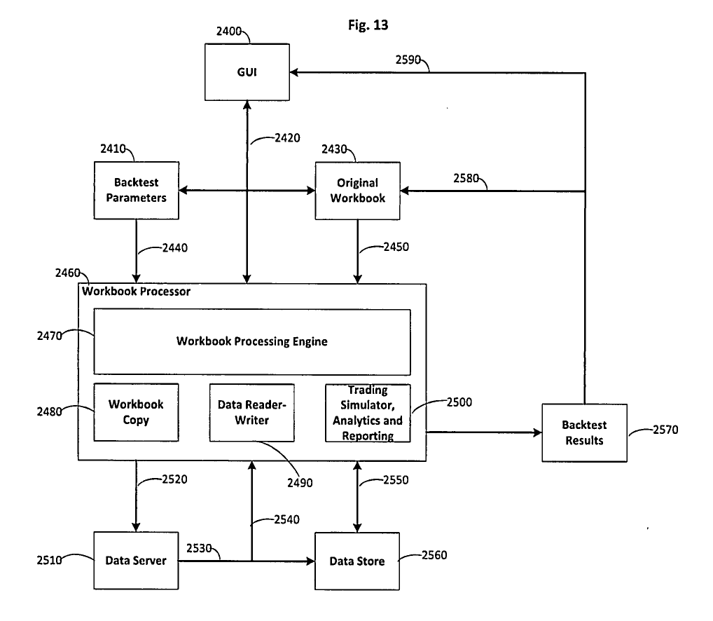

FIG. 13 illustrates backtest spreadsheet windowing systems and methods according to embodiments of the present invention. Referring to FIG. 13, the spreadsheet windowing of the present invention is a second method of backtesting, which utilizes a workbook containing a trading signal or trading strategy implemented within the spreadsheet user interface as would normally be designed for use with real-time streaming data for either decision support or semi-automated or fully-automated trading.

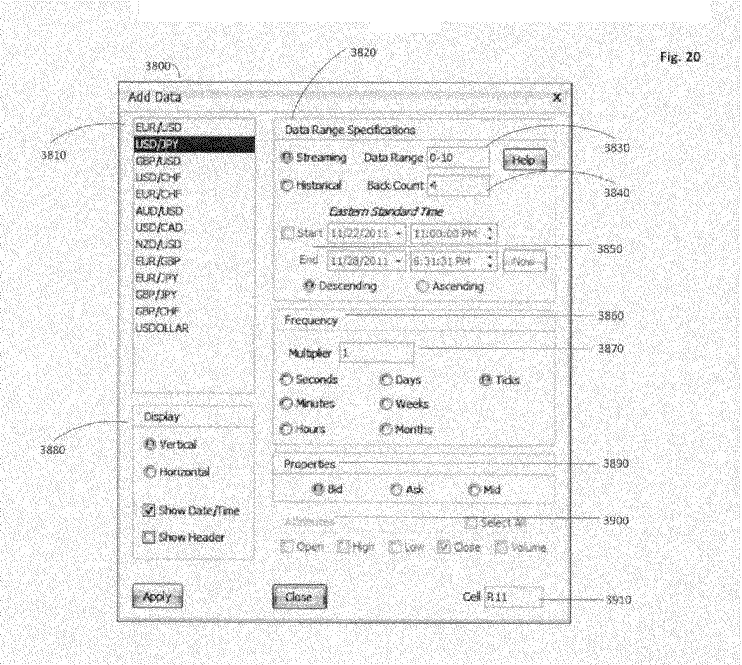

In embodiments, when a user initiates a backtest, and spreadsheet windowing backtest is used, the historical start and end date-time or count-based historical data specification, as shown in the Add Data dialog in FIG. 20, along with an additional control group for specifying the data request as a backtest and any other suitable parameters or settings as specified in the GUI 2400, is used to generate the backtest parameters that will be made available to the workbook processor 2460. In embodiments, the backtest parameters may be specified using any other method and may be transmitted using the link at 2440 over a socket, or using any other form of data transmission, including writing to any form of storage medium that the workbook processor 2460 can access.

In embodiments, the system creates a copy of the original workbook 2430 containing the strategy and makes it available to the workbook processor component 2460 that will process the backtest. The workbook processor 2460 may access the original workbook and make a copy of it, or other code in the system, including in a distributed component, may make the copy of the original workbook and make it available to the workbook processor 2460. The copy of the workbook may be transmitted over the link 2450 using any form of file transfer method, or written to any form of storage medium that the workbook processor 2460 can access.

In embodiments, the copy of the workbook is opened or otherwise accessed by the workbook processor 2460 that performs the backtesting. In embodiments, the workbook processor 2460 initiates the creation of the dynamic caches for all data dependencies by loading or otherwise running the workbook, except that the streaming data range requirements in the spreadsheet are initialized with historical data matching the backtest data specifications as returned by the query instead of the most recent real-time data. In embodiments, this includes data specifications that differ from the data specifications initially contained in the workbook. In embodiments, the number of indices required to initialize the dynamic caches is appended to the user-specified data request period such that none of the backtest period is used for initialization. For example, if the backtest data request is for 30 indices and the workbook containing the formulas requires 20 indices to initialize the dynamic cache, 50 indices of data will be queried for and processed so that the results cover the specified backtest period. In embodiments, the workbook processor 2460 uses the backtest parameters 2410 that define the historical data query and the appended initialization data requirements and other specifications and settings to initiate the data query against the data server 2510 using communication link 2520.

In embodiments, the data server 2510 returns the historical data specified by the workbook processor 2460 so that the workbook can be windowed over the data to perform the backtest. The data returned from the historical data query may be processed and held in memory and streamed into the dynamic cache of the backtest copy of the workbook. Additionally or alternatively, it may be written to any suitable storage medium including a database, or a file, in any suitable format and then read and streamed to the backtest workbook's dynamic cache. In embodiments, the data reader-writer 2490 can receive the data query results directly and hold it in memory and transform or otherwise process it and stream it directly to the backtest workbook dynamic caches and/or write the data to a storage medium and access the stored data and stream it to the dynamic caches. By streaming the data into the dynamic caches, which represent defined ranges of data or time series windows, it can be said that the workbook is being windowed over the historical data.

In embodiments, there are three modes of backtest simulation, signal only, trade-message based, and mixed. In signal only mode, the user specifies what cell or cells contain the trading signals or trading triggers, which, in embodiments, may be done with a right click operation or selection using a GUI. In embodiments, the trading simulator and analytics and reporting module 2500 comprises trading simulator logic and an extensible dictionary of values that are mapped to trading operations and which will be used in the trading simulation. For example, “Buy” and “Sell” may be mapped to market orders to buy or sell, respectively. Similarly, positive and negative numerical values are mapped to market orders to buy or sell, respectively. Other values like “Buy VWAP” might be mapped to buying at the volume weighted average price. Any suitable key-value mapping that represents a trading message that may be used by the trading simulator may be specified. Any number of cells at any location within the workbook may be supported. For example, the formulas that generate the buy and sell signals might be in two different cells, or there might be several levels of buying or selling to scale in and out of positions.

In embodiments, in trade message mode, only the trading messages generated by the workbook or workbooks are collected and streamed or written to a storage medium for use by the trading simulator. This allows for simulations using all of the data contained within a trading message, such as is defined in the named-range trading methodologies previously described, including variable amounts and dynamically computed rates for entries, stops and limit orders, or any other parameter that the user may configure for dynamic variations. In embodiments, the user may configure the dynamic variations using the spreadsheet user interface.

In mixed mode, both cells containing trading signals or triggers and trading messages are together incorporated into the trading simulation.

In embodiments, the data-reader writer 2490 contains logic that captures all changing cell values and/or all outgoing trading messages and streams the results of the workbook data windowing processing to the analytics and reporting module 2500 or writes the results to a storage medium 2560 accessible by the analytics and reporting module 2500 for completion of the backtest simulation. The code for capturing and directing the output of the workbook data processing may be a distributed component, an embedded component of the application that loads the workbook generally, or part of any other component of the workbook processor or the system generally.

In embodiments, the data that is used in the strategy within the workbook may differ from the data that is used for simulated execution. For example, a trading strategy may trigger off of the Mid price (average of the Bid and Ask prices) on a 15-minute frequency, but simulated execution of buys may use the Ask price at the tick data level and simulated execution of sells may use the Bid price at the tick level for the most accurate simulations. Further, in embodiments, if the trading strategy trigger is based upon real-time data updating for the 0th index of a streaming data range, it is triggered on tick level changes to the price data since the 0th index updates at a tick level. Some strategies may trigger off of closing prices of a lower frequency interval, such as the 1^{st} index of a 15-minute streaming data range, or a calculation based on this or a similar bar value.

Obtaining tick-level Bid and Ask prices and using them for simulation is very intensive and can be extremely computationally expensive to process depending upon the number of symbols traded, the length of the backtest, the volume of tick price updates, and the complexity of the strategy among other factors. In order to facilitate running backtests more quickly, the user may, in embodiments, specify the data that is to be used for the simulated execution prices, including lower frequency data, and thereby drastically reduce the time it takes to run the simulation.

In addition, the user may, in embodiments, specify simulated execution for both buy and sell trades and any other exiting trade, such as stop or limit using Bid, Ask, Mid, or Last Trade price, or any other available property, as well as the Open, High, Low, Close, VWAP, or any other available attribute of data that is desired, or combinations of these data types. This allows for accommodating user preferences, determining suitability of a trading strategy for a particular purpose, as well as certain types of robustness testing that seek to perturb the trading strategy and show how far it deviates from the norm using actual tick level Bid and Ask prices. In embodiments, the user may specify one or more combinations be run concurrently.

In embodiments, the analytics and reporting module 2500 receives or accesses the historical time series of trading messages and performs the trading simulation by using the backtest parameters that define the data and other preferences to be used in the simulation. The data for performing the simulation may already be available as part of the backtest data query results if run concurrently; or alternatively, it may be queried for and/or accessed on any suitable storage medium 2560 separately from the backtest trading strategy input data.

In embodiments, the analytics and reporting module 2500 performs the simulation logic using the time series of trading signals and/or trading messages and specified execution data and other price data. Using this data, it computes many derived time series and other data including the period-by-period profit and loss, as is commonly known to those skilled in the art. These derived series may then be used to compute cumulative return and perform statistical analysis on the performance of the trading strategy, generate trade-by-trade reports, generate summary reports, and generate charts, graphs, and other visualizations of the performance. These results may be collectively referred to as the backtest results 2570. The analytics and reporting module 2500 may also write out any of the derived or computed data to a storage medium 2560 using link 2550 and/or write the backtest results 2570 to the original workbook 2430 using link or a copy thereof using link 2580. In embodiments, it may also, or alternatively, publish the backtest results 2570 into a format that can be displayed by the GUI 2400 using link 2590, and/or used by any other consumers of backtest results.

In embodiments, streaming data to the backtest workbook may use the same or replicated API, dynamic cache methodologies, and other mechanisms as real-time streaming data. In alternative embodiments, simplified or otherwise modified versions of such methodologies may be used.

In embodiments, the workbook processor 2460 may be implemented in-process, or it may be a separate process that may be on the same workstation or server running the application with the embedded spreadsheet engine, or distributed in the cloud or on some other network.

In embodiments, standard events and session management techniques are used to communicate and coordinate all of the interaction between the components comprising the backtest methods of the present invention and link all of the dependent data. In embodiments, each backtest creates a session with associated data requests, raw data, trading results data, and any other suitable associations.

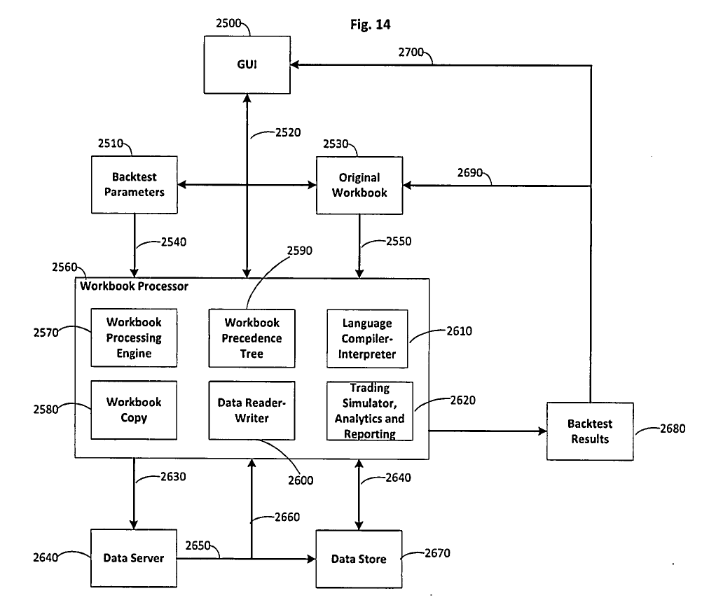

FIG. 14 illustrates backtest spreadsheet workbook translation systems and methods according to embodiments of the present invention. Referring to FIG. 14, spreadsheet workbook translation is a third method of backtesting, which utilizes a workbook containing a trading signal or trading strategy implemented within the spreadsheet user interface as would normally be done for use with real-time streaming data for either decision support, or semi-automated or fully-automated trading.

In embodiments, in workbook translation, the workbook processor 2560, instead of windowing over the data with a copy of the workbook as described in detail previously, analyzes the workbook 2530 or a copy of the workbook 2580 so that the data and trading strategy encapsulated within the spreadsheet formulas may be extracted.

Specifically, in embodiments, when using workbook translation, the workbook processor 2560 creates a precedence or dependency tree 2590 of all formulas in the workbook. In embodiments, the workbook can be analyzed directly, or other representations of the workbook, such as an XML schema representation generated by or with the workbook, can be analyzed directly or used to create intermediate representations for analysis. In embodiments, it distinguishes between spreadsheet formulas and custom functions that reflect general logic and trading logic and data reference formulas which specify the streaming data requirements, such as SYM( ) as previously described in detail, and the streaming data requirements are noted. In embodiments, the streaming data requirements are used to create the dynamic caches, which data reader-writer 2600 streams data into for execution of the trading strategy logic against. In other words, the dynamic caches become an in-memory data windowing mechanism for the translated trading strategy code. In other embodiments, the streaming data requirements may be used to establish the data query needs as well as the minimum data windowing requirements, and the translated trading strategy logic can be executed against the data in memory and/or read from any suitable storage medium for format, such as the data store at 2670

In embodiments, named-range trading parameter templates are identified and analyzed, and any formula dependencies, such as might be used to set a parameter value like a limit order rate, are noted so that these values can be passed into the trading parameters used in the simulation.

In embodiments, the workbook processor extracts the formula logic in the precedence or dependency tree 2590 and translates the formula logic into a different, suitable programming language. In embodiments, the workbook processor executes the logic on the specified data, producing the backtest results.

If the programming language used to execute the translated formulas requires compiling, it may be automatically compiled and run. If an interpreted language is used, it may be automatically executed using the interpreter. In either case, the compiler or interpreter 2610 may be embedded or distributed.

In embodiments, standard events and session management techniques are used to communicate and coordinate interactions between the components comprising the backtest methods of the present invention and link all of the dependent data. In embodiments, each backtest creates a session with associated data requests, raw data, trading results data, and any other suitable associations.

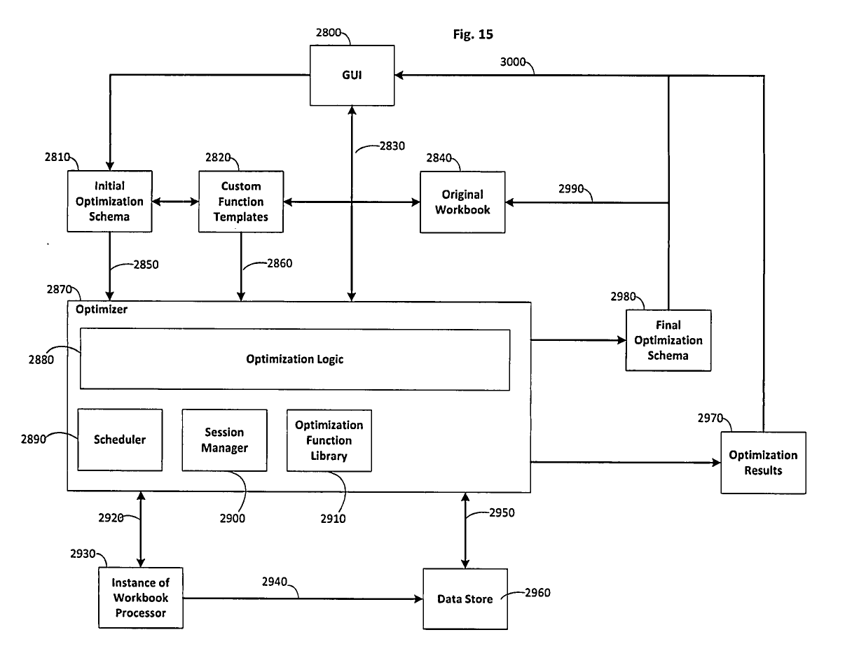

FIG. 15 illustrates trading strategy parameter optimization systems and methods according to embodiments of the present invention. Referring to FIG. 15, the spreadsheet windowing and spreadsheet translation backtest methodologies, as previously described in detail, may support any form of trading strategy parameter optimization using the systems and methods shown. In embodiments, the backtest system detailed in FIGS. 13 and 14 related to the backtest spreadsheet windowing and spreadsheet translation systems and methods that are used for performing optimization, together with the features of the optimization method described herein.

In embodiments, the settings, selections, and parameters for specifying the optimizations may originate from a GUI 2800, a data store 2960, the spreadsheet or spreadsheet formulas, named-range trading parameter templates, a command line, or any other method or methods of specifying the optimization problem and parameters.

In embodiments, the optimizer 2870 and optimization logic 2880 may be embedded in the workbook processor or distributed as shown. In embodiments, each instance of the workbook processor for both backtest methodologies may be run in an automatically spawned separate process instance, a highly parallelized single process, or a combination of the two, via an on-demand cloud compute cluster. Alternatively, the entire backtesting and optimization processing task may be performed on a single physical computer, or any combination thereof.

In embodiments, formula and parameter optimizations are specified with an initial optimization schema 2810, which may comprise any number of cell references in the original workbook 2840 containing parameters to be optimized, mapped to parameter search space specifications. For example, for brute force optimization methods, a parameter, such as the window length for the data processed by an indicator custom function, which parameter is in a cell (e.g., A1), may be mapped to a window length parameter search space of 10 through 20 in increments of 1, which can be specified in the optimization schema 2810 using any suitable notation such as [<start>, <end>, <increment>]. In this example, it would be specified as [10, 20, 1]. One skilled in the art shall recognize that any other suitable notation for optimization and search space description may be used in the same or similar way within the initial optimization schema 2810 and may be added or edited using any suitable means. The parameter search space may be defined in any suitable way to meet the requirements of any optimization method and mapped to custom function and/or specialized formula notation that the optimizer recognizes.

In other embodiments, search space parameters may be specified for each numerical parameter to be optimized within the formula itself using any suitable notation. For example, the expression [<start>, <end>, <increment>] may be used, where the first parameter specified would be used if running the workbook on real-time streaming data, allowing for specification at formula creation time without causing the formula to fail to run in the context of the workbook as a result of the special syntax. In embodiments, the first parameter, or the entire parameter notation, may optionally be replaced with a generated final optimization schema 2980 automatically or with a user-initiated operation. In embodiments, the formula level search space parameters to be optimized may be communicated directly to the optimizer 2870 via the custom function templates or any other suitable means, or they may be added to the initial optimization schema 2810 by any suitable means.

In embodiments, any parameter in the indicator custom function template key-value pairs 2820 may be optimized using a comma-separated list of values using any suitable notation. For example, the expression [<start>, <end>, <increment>] may be used, where the first parameter specified would be used if running the workbook on real-time streaming data with any indicator custom functions, allowing for specification of optimization search space parameters as defaults for indicator custom functions, or as user-specified preferences. In embodiments, the custom function template values to be optimized are added to the initial optimization schema 2810 and later replaced with the optimal values contained in the generated final optimization schema 2980.

In embodiments, optimization schema 2810 and 2980 may be applied to a workbook from which the schema was generated. At the conclusion of any optimization, a final optimization schema 2980 may be generated and associated with the workbook it was generated from and is then available to be applied to the workbook, but containing only the optimal parameters. In embodiments, these parameters may be automatically propagated to the workbook, including an instance running in real time without any additional user action, or the final optimization schema 2980 may be saved and applied to the workbook at any time. In embodiments, the initial optimization schema 2810 may be regenerated at any time when initiating an optimization. In embodiments, any part of the optimization schema that does not map back to the workbook for any reason, such as due to a user's changes to the workbook, may simply be ignored, with errors written to a log.

In embodiments, named-range trading ticket template or message parameter optimizations are supported in the optimization schema in the same way, where any suitable notation is used to represent the parameter search space. For example, for values that are dynamically generated, like a limit rate, the notation may be [−<lower-boundary>, <cell-ref-with-rate>, +<upper-boundary>,<increment>] where <cell-ref-with-rate> maps to the cell containing the dynamically computed rate in the workbook 2840.

In embodiments, optimizations may be processed periodically by the scheduler 2890 as set up by a user for each workbook using an optimization scheduler, and may be offline, or may run concurrently with the running of a workbook containing real-time streaming data ranges, whether used for decision support, semi-automated or fully automated trading. In embodiments, certain events may also trigger an optimization to be performed, such as recent sustained losses above a threshold value, with the option of halting trading until the optimization is complete and has been applied to the workbook. In embodiments, final optimization schemas 2980 may be applied on the fly to a workbook 2840, either automatically or manually without recompiling or any other interruptions to the running workbook.

In embodiments, the analytics produced by the workbook processor 2930 are made available to, or accessible by, the optimizer 2870 via the links at 2920 and 2950 for optimization functions that require a feedback loop. In embodiments, the optimization results 2970 are returned and may comprise performance metrics, session and other events that can be used to drive automation and session management tasks or provide the user with feedback via link 3000.

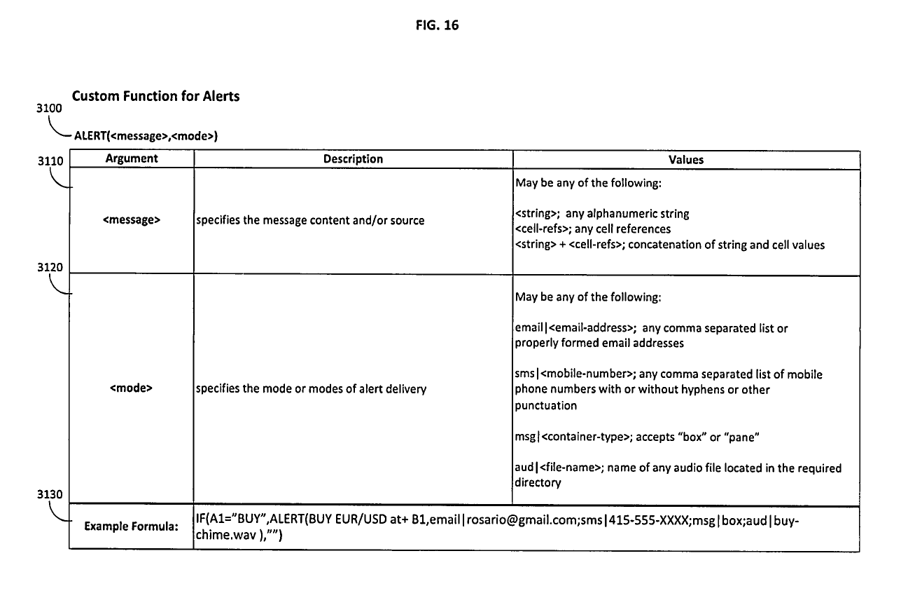

FIG. 16 illustrates an ALERT( ) custom function according to embodiments of the present invention. Referring to FIG. 16, embodiments of the present invention include a custom function, ALERT( ) 3100, which allows for sending a message (e.g., email and/or SMS), creating a system message, playing a sound file, other notifications, or combinations thereof. In embodiments, the ALERT( ) custom function takes two arguments ALERT(<message>,<mode>) as shown in the table.

In embodiments, the argument <message> 3110 specifies the message content and/or source. The value may be a string of any alphanumeric characters, any cell references, or any concatenated combination of strings and cell references using “+” as the concatenation operator, for example A1+Buy+B1. In embodiments, discontinuous cell references are comma separated and automatically concatenated together with spaces in between the value from each cell in the message body. In embodiments, cell references that indicate a one-dimensional array, such as A1:D1 or A1:A4, may have their contents automatically concatenated together with spaces in between the value from each cell in the message body.

In embodiments, the argument <mode> 3120 specifies mode or modes of the alert message delivery. In embodiments, the supported values may be a semi-colon separated list of any number of the following examples:
1. email|<email-address> where <email-address> is any comma-separated list of properly formed email addresses
2. sms|<mobile-number> where <mobile-number> is any comma-separated list of mobile phone numbers with or without hyphens or other punctuation
3. msg|<container-type> where <container-type> accepts “box” for a pop-up message box dialog, or “tab” for posting the message to the messages tab docking panel
4. aud|<file-name> where <file-name> is the name of any audio file located in the required directory

In embodiments, the ALERT( ) custom function may be nested within other spreadsheet formulas that can be used to conditionalize the sending of the alert, as shown in the example at 3130.

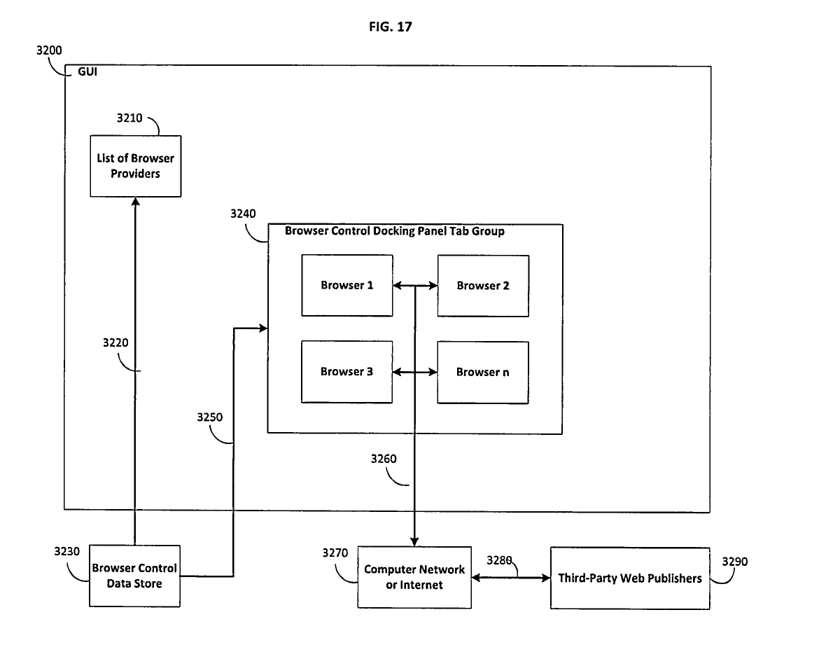

FIG. 17 illustrates browser-based controls according to embodiments of the present invention. Referring to FIG. 17, the system of the present invention may within its GUI optionally contain browser-based controls 3240 that display content provided by third-party web publishers 3290. In embodiments, such content may contain news, market analyses, economic calendars, or other high value information, and may also contain advertisements with or without click-through capabilities that may open within the browser control or within a new web browser window. In embodiments, this information may be updated continuously or periodically as would be done on the publisher's primary website.

In embodiments, each browser control is permissioned through an administration application or other configuration management method that creates a data store 3230, such as data entered into a database or storage medium or an XML, text, or other file. In embodiments, the permissioning maps a provider's URL to an instance of a browser control as well as other metadata about the provider, the content that will be published via the URL, and any other suitable information.

In embodiments, once permissioned, an optional GUI-based display options control 3200 automatically displays the browser control and any associated descriptive information that a user might use to decide which to view. This GUI-based control allows for selection and de-selection of provider browser controls. Each provider browser control, when enabled, is displayed and may be moved onto any monitor, tiled within a tab frame, or docked within a tab group.

In embodiments, logic spawns the browser control and associates it with the specified provider configuration information source when selected for display. In embodiments, other logic tracks the number of users that have a provider's control displayed, the number of click-throughs on advertisements in a provider's content, and any other suitable metrics.

In embodiments, users may also add a browser-based control and specify the URL so that they can conveniently access third-party websites of interest within the system GUI.

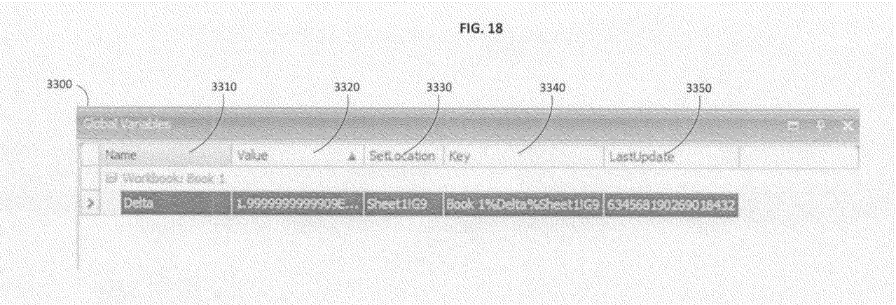

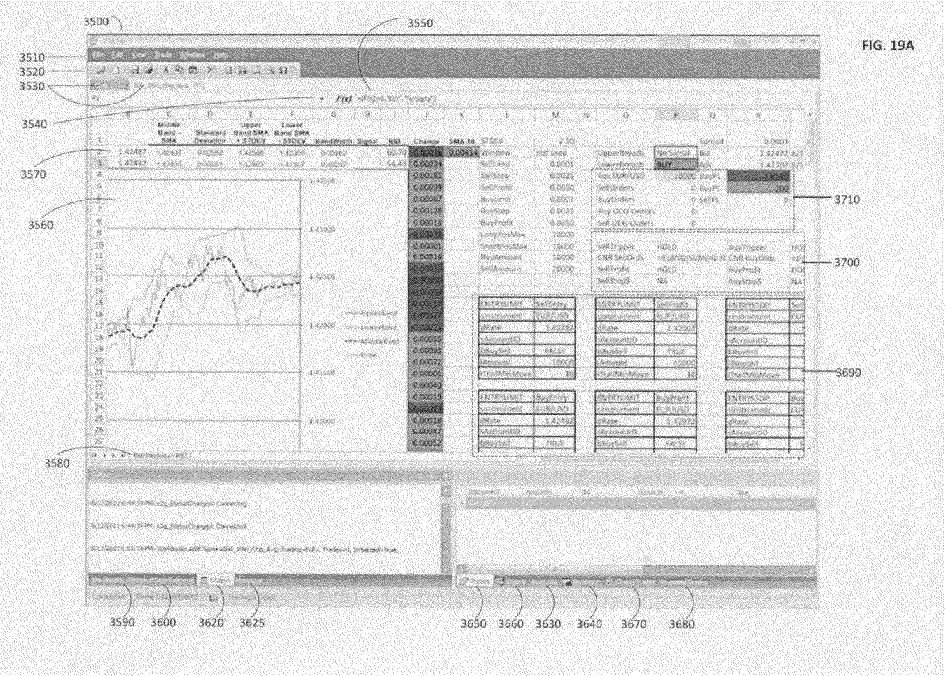

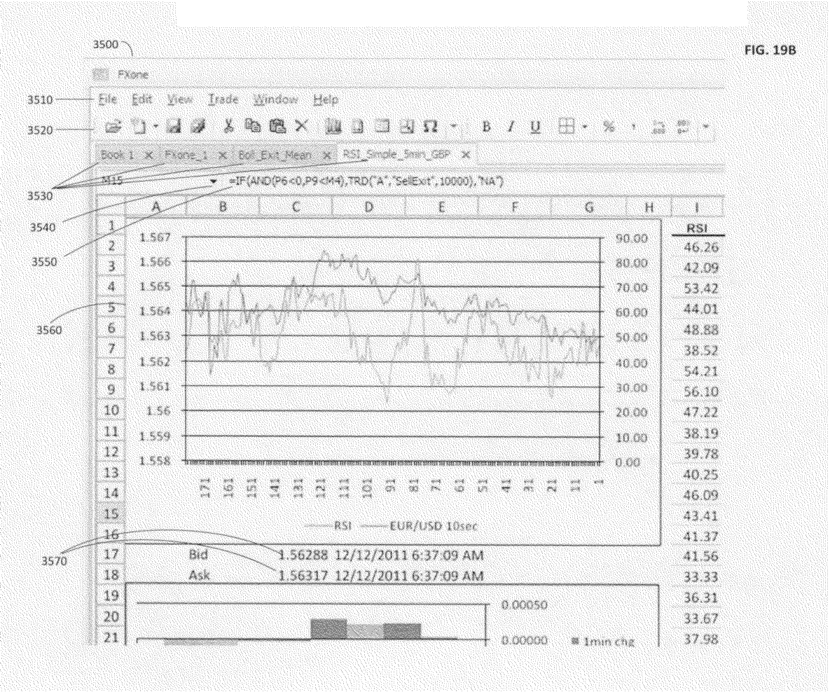

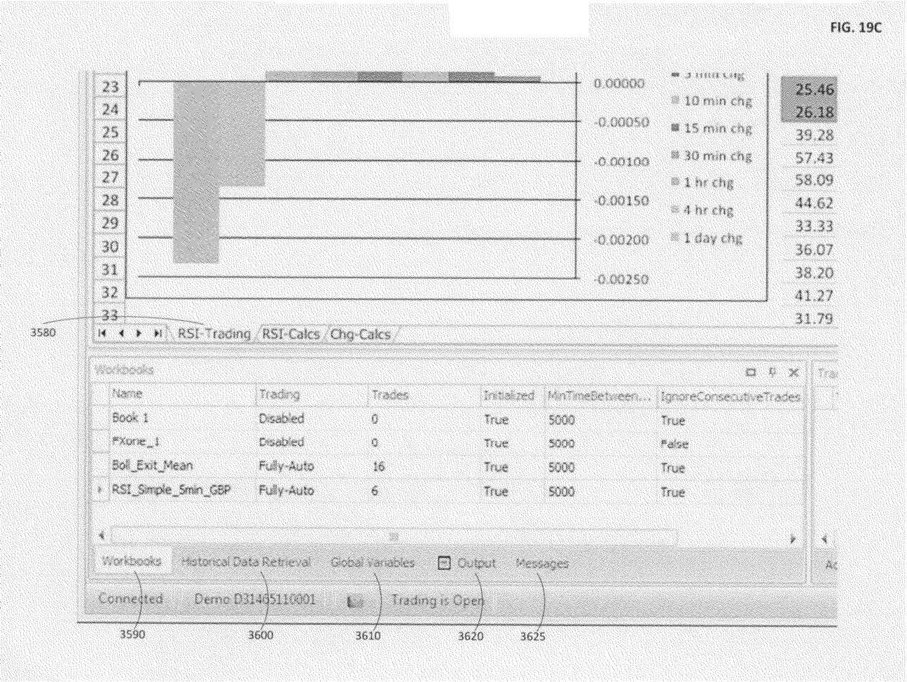

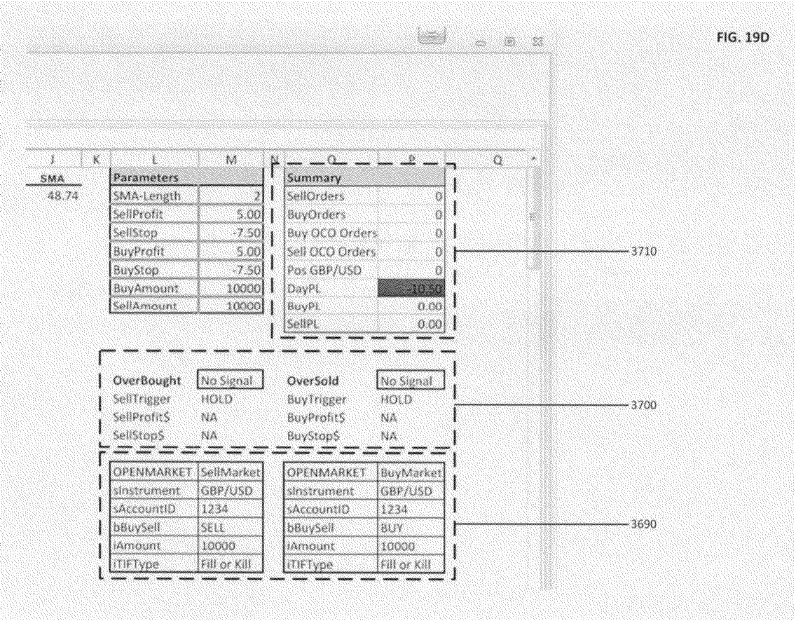

FIG. 18 illustrates a global variable display according to embodiments of the present invention. Referring to FIG. 18, the illustration shows an example of a real-time display of the global variables that are created with an example custom function SET( ). In embodiments, the custom function for creating and setting global variables has the following argument structure:

SET(“<variable-name>”,<value>,<init-value>,<scope>)

In embodiments, the <variable-name> argument may be any double quoted string, or it may be a cell reference where a string is contained. In embodiments, the <value> argument is not double quoted, and may be any value whether numerical, alphanumeric, a string, or a cell reference containing any of the same value types. Since the value may be a cell reference, it may be a dynamically computed and changing value that updates in real time. In embodiments, the <init-value> argument is an optional initial value, which may be set with a static initial variable or a cell reference containing an initial value. In embodiments, if <init-value> is not specified, the default initial value for all global variables upon creation will be 0. In embodiments, global variables have scoping options and may be scoped using an optional fourth argument <scope>. The global variables may be scoped to the whole system using the argument “global,” to a workbook using the argument “book,” or a worksheet using the argument “sheet.” In embodiments, the default scope is at the workbook level if the argument is omitted.

In embodiments, the custom function GET( ) may be used to get the real-time updating value of any global variable, and it may have the following argument structure:

GET(“<variable-name>”)

In embodiments, the <variable-name> argument is double quoted. The custom function GET( ) may be nested within any other formula for real-time calculations using the global variable values. In embodiments, if the global variable being referenced does not exist, GET( ) will return 0 by default.

In embodiments, the global variables display user interface 3300 is a docking GUI tab pane for viewing global variables and their real-time values grouped by scope. The name of each variable may be seen in the name column 3310. The current value of each global variable, which may update in real time, may be seen in the value column 3320. The cell location in the spreadsheet where the SET( ) custom function that creates the global variable can be seen in the set location column 3330. The key into the in-memory cache for the global variable can be seen in the key column 3340. The date-time of the last update can be seen in the last update column 3350. In embodiments, the global variables display updates in real time, and in other embodiments, it may contain any other suitable information about global variables.

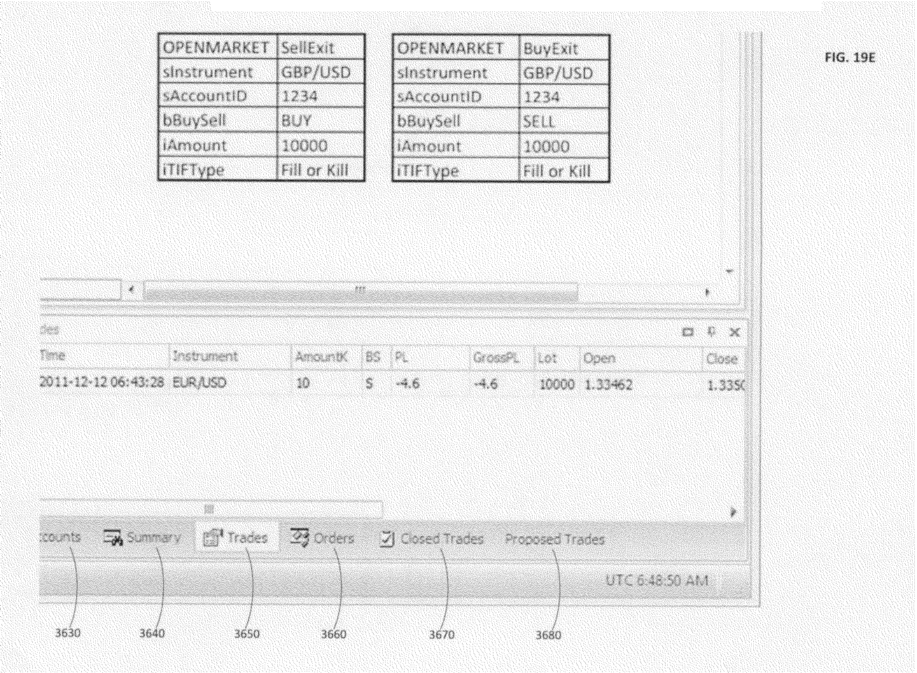

FIG. 19A illustrates a user interface according to embodiments of the present invention. FIGS. 19B-E illustrate segment views of a user interface according to embodiments of the present invention. Referring to FIG. 19A-E, the illustration shows a main system user interface 3500 with the following features:
1. An embedded spreadsheet user interface workbooks 3530 as one or more docking tab groups within the main system user interface, with:
   a. One or more worksheets that comprise each workbook 3580
   b. Named range dropdown menu 3540
   c. Formula bar 3550
   d. Embedded chart object containing references to data in cells in the spreadsheet user interface that update in real time 3560
   e. Custom functions SYM( ) pulling in real-time data updates 3570
   f. Custom real-time feedback loop functions POS( ), ORD( ) and CSD( ) receiving real-time order and position state information 3710
   g. Trading custom functions TRD( ), CAN( ) and CNR( ) referencing named ranges and other cells 3700
   h. Named-range-based trade order templates 3690
2. Docking tab groups for displaying the GridModel tables as previously defined, including the following:
   a. Workbooks tab showing all open workbooks state including data initialization and trading options and other workbook level settings 3590
   b. Historical data query tab showing query status and results 3600
   c. Global variables display 3610 as also shown in FIG. 18
   d. Console output showing all trading operations, and other key operations and errors and other logging 3620
   e. Message tab showing all messages from brokers and instant messaging relationships 3625
   f. Trades grid showing all open positions 3650
   g. Orders grid showing all pending orders in the market 3660 h. Accounts grid showing key information for each account 3630
   i. Summary grid showing a summary of all information related to all the accounts 3640
   j. Closed trades grid showing all closed trades for the current day 3670
   k. Semi-automated proposed trades staging tab 3680
3. Tab with browser based controls displaying content from web publishing partners (not shown).
4. Menu bar for accessing manual trading order tickets and performing a range of typical operations 3510
5. Toolbar for shortcut buttons for accessing a range of features such as the data chooser dialog, as more fully described later, and performing a range of operations 3520
   It shall be noted that one or more of the above-listed features may be provided to a user in one or more user interfaces. Furthermore, one skilled in the art shall recognize that additional features and data may also be provided.

FIG. 20 illustrates a data selection user interface according to embodiments of the present invention. Referring to FIG. 20, the illustration shows the data selection user interface 3800, which may be used to select what type of data and how to display it in a spreadsheet user interface. In embodiments, together, selections from each control may fully specify the formulas using the custom function SYM( ) as previously described and the data that will be added to the dynamic cache which will then be updated to the spreadsheet user interface in the case of streaming ranges, or static data that will be added to the spreadsheet user interface in the case of historical data ranges.

In embodiments, a window displaying all of the available data symbols 3810 allows selection of one or more tradable symbols from multiple asset classes or other types of data. The data range specifications 3820 allow for selection of a streaming range, where the range indices are specified at 3830, such as 0-10 (which is the current period through the 10^{th} period back for a total of 11 periods). In embodiments, streaming ranges create entries in the dynamic cache for data that is not already present in the cache, as previously described in detail.

In embodiments, the selection of a historical data range will allow for the specification of the count 3840 of periods, which correspond to indices from the present time, or the End date-time, which can be set to now, going back in time. Alternatively, the user may specify the start and end dates and times 3850 that they wish to have covered. In embodiments, historical data is retrieved from the data provider's server and added into the spreadsheet user interface without any underlying formulas or corresponding dynamic cache entries.

In embodiments, the display options 3880 allow specification of vertical or horizontal orientation and options for showing the date and time in a separate adjacent range of cells as well as a symbol label in the header cell over the data range.

In embodiments, the frequency of the data may be specified at 3860. In embodiments, when ticks are selected, the interval multiplier control 3870 becomes unavailable since there is no aggregation taking place with ticks. In other embodiments, the interval multiplier may be used with ticks to create n-tick aggregations. In embodiments, attributes remain available for specification with n-tick aggregations, unlike with raw tick data.

In embodiments, the property of the data is specified at 3890, and may generally be the bid price, ask price, midpoint of the bid and ask prices and volume. Other properties may also be supported.

In embodiments, the data attribute may be specified at 3900. Data attributes are generally at least open, high, low, close, and volume, such as would be used to create a candlestick chart or by many types of technical indicators. Any number of attributes whether available on the feed or computed by the system may be supported. Attributes represent different forms of aggregation logic, as previously described.

At 3910, a display showing the current cell where the data insertion will begin is shown. In embodiments, different operations to add data may be done without closing the dialog by making a selection and clicking the apply button. In alternative embodiments, any suitable options, data, data properties, data attributes, or operations to be performed on any of the data, including, but not limited to, the selection of indicators for computation of real-time indicator data values to be added to the dynamic cache and spreadsheet user interface, as well as their input data and output data and other options, may be specified in the data selection user interface or a similar user interfaces or other methods.

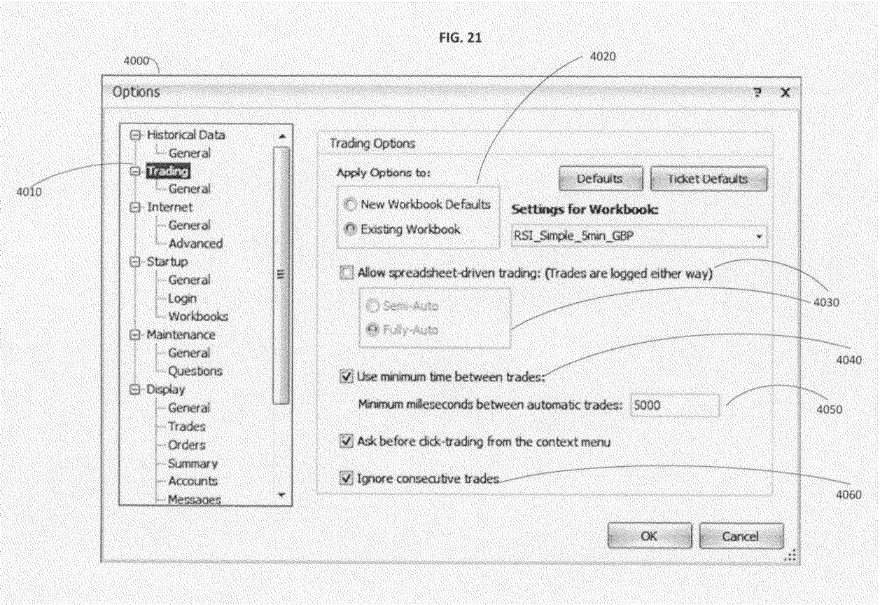

FIG. 21 illustrates an options user interface according to embodiments of the present invention. Referring to FIG. 21, the illustration shows the trading options 4010 section of an options user interface 4000.

In embodiments, users may use the trading options user interface to make changes to trading options for a currently selected workbook, or they may set trading option defaults for any new workbook by making a selection using the control at 4020.

In embodiments, spreadsheet-driven trading may be enabled or disabled at 4030, and if enabled, can be set to semi-automated or fully-automated trading. As previously noted, in embodiments, fully-automated trading causes all trading messages to be sent directly to the broker's trading server via the API for execution; and semi-automated trading first presents all trades in the proposed trades user interface of the system for review and acceptance or rejection.

In embodiments, a minimum timer to enforce between trades from calls to the same trading function may be enabled at 4040. The setting, which may be in milliseconds, may be entered into the provided field at 4050. When set, the timer in the trading options user interface is a global setting that may be overridden by changing the optional timer argument in the trading functions, as previously described in detail. In embodiments, the timer method of the present invention allows for controlling unintentional trades during automated trading from calls to trading custom functions where logic that controls order entry relies upon other information such as feedback loop custom functions to determine if a trade should be initiated. In embodiments, the timer covers for any latency in the updating of any dependent values. For example, a trading signal might be designed to either buy or sell for extended periods of time, and the trading logic that calls the trading custom functions might look at the current position to determine whether to buy or sell. If there is any latency in updating the current position, the trading custom functions may be called repeatedly. This makes it possible to simplify trading strategy design greatly since the user does not need to account for this by forcing a trading signal to return the buy or sell signal only at the instant the condition is met and without reliance upon current open position state.

In embodiments, another aspect of embodiments of the present invention is the ability to enable ignoring consecutive trades in the same direction as shown at 4060. In embodiments, this means that if a buy trade is executed, and then the position is closed either manually, or by a stop loss, take profit, or other offsetting trade, the next trade, if a buy, will be ignored. However, in embodiments, if the next trade is a sell, it will be executed. This functionality greatly simplifies automated strategy construction because the user can eliminate getting whipsawed (i.e., going into and out of the market repeatedly, especially in the same direction after getting taken out with a limit order, as is familiar to those skilled in the art) without having to reconstruct historical position state explicitly.

In other embodiments, additional settings effectively ignore trades based upon many other conditions, such as position size, number of lots, a profit and loss threshold, and any other suitable constraint.

In embodiments, one or more user interfaces may include a field “Direction Check” to receive input from a user. In embodiments, “Direction Check” may mean that if the state of the named array is a state where the trade request is permitted and trading in the same direction as the last trade request that resulted in a position that has been subsequently closed is enabled using the “Direction Check” field or “Ignore Consecutive Trades” option 4060 (FIG. 21) which prevents opening a position in the same direction as the most recently closed trade as previously described, then the trade request is not made.

In embodiments, one or more computing systems, or devices, may be configured to perform one or more of the methods, functions, and/or operations presented herein. Systems that implement at least one or more of the methods, functions, and/or operations described herein may comprise a trading application or applications operating on at least one computer system. The computer system may comprise one or more computers and one or more databases. The computer system may be a distributed system or a cloud-based computer system.

It shall be noted that the present invention may be implemented using one or more instruction-execution/computing devices or systems capable of processing data, including, without limitation phones, laptop computers, desktop computers, tablet computers, and servers. The present invention may also be implemented into other computing devices and systems. Furthermore, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

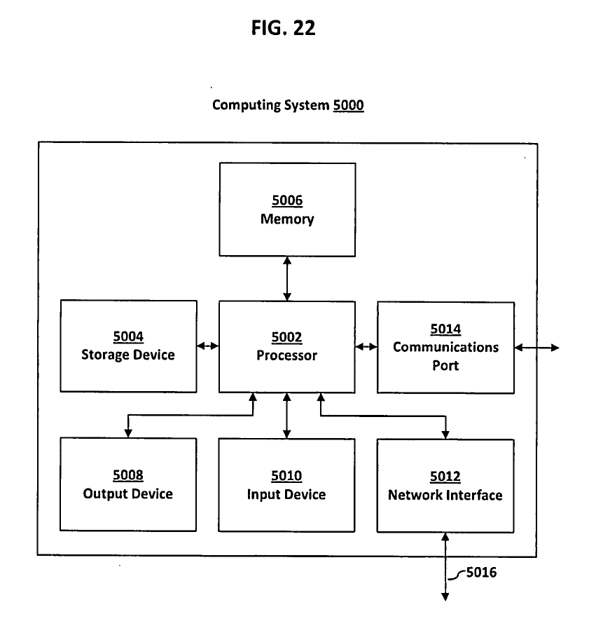

FIG. 22 depicts a functional block diagram of an embodiment of an instruction-execution/computing device 5000 that may implement or embody embodiments of the present invention, including without limitation a client and a sever. As illustrated in FIG. 22, a processor 5002 executes software instructions and interacts with other system components. In an embodiment, processor 5002 may be a general purpose processor such as (by way of example and not limitation) an AMD processor, an INTEL processor, a SUN MICROSYSTEMS processor, or a POWERPC compatible-CPU, or the processor may be an application specific processor or processors. A storage device 5004, coupled to processor 5002, provides long-term storage of data and software programs. Storage device 5004 may be a hard disk drive and/or another device capable of storing data, such as a magnetic or optical media (e.g., diskettes, tapes, compact disk, DVD, and the like) drive or a solid-state memory device. Storage device 5004 may hold programs, instructions, and/or data for use with processor 5002. In an embodiment, programs or instructions stored on or loaded from storage device 5004 may be loaded into memory 5006 and executed by processor 5002. In an embodiment, storage device 5004 holds programs or instructions for implementing an operating system on processor 5002. In one embodiment, possible operating systems include, but are not limited to, UNIX, AIX, LINUX, Microsoft Windows, Android, and the Apple MAC OS. In embodiments, the operating system executes on, and controls the operation of, the computing system 5000.

An addressable memory 5006, coupled to processor 5002, may be used to store data and software instructions to be executed by processor 5002. Memory 5006 may be, for example, firmware, read only memory (ROM), flash memory, non-volatile random access memory (NVRAM), random access memory (RAM), or any combination thereof. In one embodiment, memory 5006 stores a number of software objects, otherwise known as services, utilities, components, or modules. One skilled in the art will also recognize that storage 5004 and memory 5006 may be the same items and function in both capacities. In an embodiment, one or more of the methods, functions, or operations discussed herein may be implemented as modules stored in memory 5004, 5006 and executed by processor 5002.

In an embodiment, computing system 5000 provides the ability to communicate with other devices, other networks, or both. Computing system 5000 may include one or more network interfaces or adapters 5012, 5014 to communicatively couple computing system 5000 to other networks and devices. For example, computing system 5000 may include a network interface 5012, a communications port 5014, or both, each of which are communicatively coupled to processor 5002, and which may be used to couple computing system 5000 to other computer systems, networks, and devices.

In an embodiment, computing system 5000 may include one or more output devices 5008, coupled to processor 5002, to facilitate displaying graphics and text. Output devices 5008 may include, but are not limited to, a display, LCD screen, CRT monitor, printer, touch screen, or other device for displaying information. Computing system 5000 may also include a graphics adapter (not shown) to assist in displaying information or images on output device 5008.

One or more input devices 5010, coupled to processor 5002, may be used to facilitate user input. Input device 5010 may include, but are not limited to, a pointing device, such as a mouse, trackball, or touchpad, and may also include a keyboard or keypad to input data or instructions into computing system 5000.

In an embodiment, computing system 5000 may receive input, whether through communications port 5014, network interface 5012, stored data in memory 5004/5006, or through an input device 5010, from a scanner, copier, facsimile machine, or other computing device.

In embodiments, computing system 5000 may include one or more databases, some of which may store data used and/or generated by programs or applications. In embodiments, one or more databases may be located on one or more storage devices 5004 resident within a computing system 5000. In alternate embodiments, one or more databases may be remote (i.e., not local to the computing system 5000) and share a network 5016 connection with the computing system 5000 via its network interface 5014. In various embodiments, a database may be a relational database, that is adapted to store, update, and retrieve data in response to SQL-formatted commands.

One skilled in the art will recognize no computing system or programming language is critical to the practice of the present invention. One skilled in the art will also recognize that a number of the elements described above may be physically and/or functionally separated into sub-modules or combined together.

It shall be noted that embodiments of the present invention may further relate to computer products with one or more non-transitory computer-readable media that have computer code thereon for performing various computer-implemented operations. The media and computer code may be those specially designed and constructed for the purposes of the present invention, or they may be of the kind known or available to those having skill in the relevant arts. Examples of non-transitory computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a computer. Examples of program modules include libraries, programs, routines, objects, components, and data structures. In distributed computing environments, program modules may be physically located in settings that are local, remote, or both.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A computer-implemented trading system comprising:
a trading application for receiving and analyzing data, the trading application comprising:
a user interface that provides one or more features that facilitate displaying data in memory to a user and receiving input from the user;
a spreadsheet user interface that provides one or more features that facilitate displaying data in memory to a user and receiving input from the user;
an embedded spreadsheet engine, which is in-process with the trading application, that is communicatively coupled to the spreadsheet user interface and to the user interface and that receives from the user a request comprising one or more parameters; and
a dynamic cache communicatively coupled to the embedded spreadsheet engine that is accessed by the embedded spreadsheet engine using a key that is based upon the one or more parameters in the request to access data in the dynamic cache to process, at least in part, the request, wherein data in the dynamic cache is stored in key-value pairs, with each key being based upon one or more parameters and each value being a value related to the one or more parameters.

2. The computer-implemented trading system of claim 1 further comprising:
an event subscription manager that:
for each data stream specified by a user, registers with one or more data servers to receive event notices from the one or more data servers; and
responsive to receiving data from one or more data servers, populates the dynamic cache with data by creating entries in a table of keys in the dynamic cache, a key in the table of keys being based upon one or more parameters associated with data.

3. The computer-implemented trading system of claim 2 further comprising:
a data aggregation processor that, responsive to a request for data not in the dynamic cache, receives data from one or more data services and responsive to the received data not being in a form to satisfy the request, performs one or more transformations on at least some of the data and stores the transformed data in the dynamic cache.

4. The computer-implemented trading system of claim 3 wherein:
at least one of the caches in the dynamic cache comprises streaming data and the data aggregation processor performs a transformation in real time on at least some of the streaming data, historical data, or a combination thereof.

5. The computer-implemented trading system of claim 1 wherein:
at least one of the caches in the dynamic cache is an indexed cache that stores a rolling time-ordered series of data that is updated in real time.

6. The computer-implemented trading system of claim 1 wherein the application is further configured to perform at least one of:
publishing data for consumption by one or more third-parties; and
subscribing to receive data from one or more third-party for use by a user of the application.

7. A computer-implemented method for generating a trading message using a trading application comprising an in-process embedded spreadsheet engine, the method comprising:
receiving values for a trading-related parameter into an array in a dynamic cache communicatively coupled to an embedded spreadsheet engine that accesses data in the array in the dynamic cache using keys based upon one or more parameters in a function that defines the array, data in the dynamic cache being stored in key-value pairs;
generating a display of the array using a spreadsheet user interface communicatively coupled to the embedded spreadsheet engine, the values being updated according to a specified condition defined by the function;
generating a trading trigger using at least some of the values in the array; and
responsive to the trading trigger yielding an affirmative trading trigger, generating the trading message.

8. The computer-implemented method of claim 7 wherein the array comprises a real-time array and the step of receiving values for a trading-related parameter in the array:
receiving real-time values for a trading-related parameter and updating at least one cell in the array with one or more real-time values based upon one or more parameters in the function that defines the array.

9. The computer-implemented method of claim 8 wherein:
the array is a rolling window array such that as a new value is added into the array according to one or more parameters in the function that defines the array, the prior values in the array are shifted and a last value in the array is dropped.

10. The computer-implemented trading method of claim 8 further comprising:
responsive to the function requesting data that is not in the dynamic cache, receiving data from one or more data services and responsive to the received data not being in a form to satisfy the function, performing one or more transformations on at least some of the data and storing the transformed data into at least part of the array in the dynamic cache.

11. The computer-implemented trading method of claim 7 further comprising:
receiving input from a user via a user interface that defines a named-range trading parameter template, the named-range trading parameter template comprising sufficient information for a trade message, the named-range trading parameter template being assigned a name by the user as an identifier for that particular trading message template to facilitate referencing the trading message template within one or more trading functions in the trading application.

12. The computer-implemented trading method of claim 11 further comprising:
displaying the named-range trading parameter template as a collection of cells in the spreadsheet user interface.

13. The computer-implemented trading method of claim 11 further comprising:
receiving the trigger as a trigger function in a cell in the spreadsheet user interface, the trigger function comprising one or more parameters in which at least one of the parameters is the name of the named-range trading parameter template.

14. The computer-implemented method of claim 11 wherein the named-range trading parameter template comprises at least one or more of the following fields:
a “Status” field configured to receive a state value of a most recent trade request originated from the named-range trading parameter template;
a “CancelFirst” field configured to receive one or more assigned names of named-range trading parameter templates that comprise trade messages;
a “CloseFirst” field configured to receive one or more assigned names of named-range trading parameter templates that comprise trade messages; and
an “IfDone” field configured to receive one or more assigned names of named-range trading parameter templates that comprise trade messages,
wherein the one or more of the fields allowing transaction controls affecting execution of the trading message.

15. The computer-implemented method of claim 14 wherein the trade message is further processed with state management and automation comprising one or more of the following conditional tests:
a Status test that checks whether a state of a last order submitted using the named-range trading parameter template to determine whether the trading message is allowed to be sent for execution;
a Cancel First test that, responsive to the trade message being permitted, checks whether any of the named-range trading parameter templates in the CancelFirst field having pending trading messages, and responsive any such pending trading message or messages, automatically cancelling any such pending trading message or messages before sending the present trading message for execution;
a Close First test that, responsive to the trade message being permitted, checks whether any of the named-range trading parameter templates in the CloseFirst field having open positions from the named-range trading parameter templates, and responsive any such positions, automatically closing any such positions before sending the present trading message for execution; and
an If Done test that, responsive to the trade message being permitted, automatically processes trading message from the named-range trading parameter templates in the IfDone field when the when the present trading message has been executed.

16. A non-transitory computer-readable medium or media comprising one or more sequences of instructions which, when executed by one or more processors, causes steps to perform the method claim 7.

17. A computer-implemented method for facilitating publication of and subscription to trading-related information among a plurality of third parties, the method comprising:
receiving a content service registration from a publisher user using a first instance of a trading application;
responsive to receiving a request from a subscriber user to subscribe to the content service, the request being generated by a second instance of the trading application in which a subscriber user entered a subscription request into a user interface of the second instance of the trading application, the request comprising a unique identifier of the content service, associating the subscriber user with the content service; and
responsive to receiving a content message for the content service from the publisher user, the content message being generated by the first instance of the trading application in which the published user entered a publication request into a user interface of the first instance of the trading application that causes the content message to be published, the publication request comprising the unique identifier of the content services, broadcasting the content message.

18. The computer-implemented method of claim 17 wherein the content message is a trading message and the method further comprises:
generating a subscriber trading message for the subscriber user by performing at least one of the steps comprising:
responsive to the subscriber user having identified one or more modifying parameters, modifying the trading message according to the one or more parameters to generate the subscriber trading message; and
responsive to the subscriber user not having identified one or more modifying parameters, mirroring the trading message to generate the subscriber trading message; and
sending the trading message and the subscriber trading message to one or more brokers for execution.

19. The computer-implemented method of claim 18 further comprising:
aggregating the trading message and the subscriber trading message into one or more aggregate block trades for execution.

20. The computer-implemented method of claim 17 wherein the content message is a data message and the step of broadcasting the content message further comprises:
broadcasting the data message to the subscriber user via the second instance of the trading application.
